(19) United States
(12) Patent Application Publication
(10) Pub. No.: US 2004/0230951 A1
(43) Pub. Date: Nov. 18, 2004

(54) Method for Building Highly Adaptive Instruction Based on the Structure as Opposed to the Semantics of Knowledge Representations

(76) Inventor: Joseph M. Scandura, Narberth, PA (US)

Correspondence Address: JOSEPH M. SCANDURA, PH.D., 1249 GREENTREE LA., NARBERTH, PA, 19072, US

(21) Appl. No.: 10/249,355

(22) Filed: Apr. 2, 2003

(51) Int. Cl. G06F 9/44

(52) U.S. Cl. 717/120

(57) ABSTRACT

Instructional systems are assumed to include one or more learners, human and/or automated, content, means of presenting information to and receiving responses from learners, and an automated tutor capable of deciding what and when information is to be presented to the learner and how to react to feedback from the learner based on configurable options and the current status of the learner model. This invention discloses a method for authoring and delivering highly adaptive instructional systems based on abstract syntax tree representations of the problems to be solved by learners and, of the requisite knowledge structures to be acquired. Authoring includes: a) receiving and/or constructing abstract syntax tree representations of essentially any kind of to-be-acquired knowledge (KR), b) methods for representing problem schemas in an observable medium enabling communication between tutors and learners and c) configuring the learning and tutorial environment to achieve desired learning. Delivery includes general-purpose methods for: d) generating specific problems, updating the learner model and sequencing diagnosis and instruction.

### CROSS REFERENCE TO RELATED APPLICATIONS

This application builds directly on U.S. Pat. No. 6,275,976, entitled “Automated Method for Building and Maintaining Software including Methods for Verifying that Systems are Internally Consistent and Correct Relative to their Specifications”. In practice, the preferred embodiment also benefits directly from software technology based on a patent application (Ser. No. 09/636676) entitled: Method for Developing and Maintaining Distributed Systems via Plug and Play, submitted Jun. 4, 2000. It also builds on: Scandura, J. M. Structural Learning Theory in the Twenty First Century. Journal of Structural Leaning and Intelligent Systems, 2001, 14, 4, 271 -306, and Scandura, J. M. Domain specific structural analysis for intelligent tutoring systems: automatable representation of declarative, procedural and model-based knowledge with relationships to software engineering. Technology, Instruction, Cognition & Learning, 2003, 1, 1, 7-58.

### APPENDIX DATA

Article on Structural Learning Theory in the Twenty First Century Structural Learning Theory in the Twenty First Century

http://www.scandura.com/TICL_On_Line/_disc/00000002.htm

Article on Domain Specific SA Domain Specific SA

http://www.oldcitypublishing.com/TICL/TICL1.1full%20text/Scandura.pdf

### BACKGROUND OF INVENTION

The enormous potential of intelligent tutoring systems (ITS) has been recognized for decades (e.g., Anderson, 1988; Scandura, 1987). Explicit attention to knowledge representation, associated learning theories and decision making logic makes it possible to automate interactions between the learner, tutor and content to be acquired (commonly referred to as the expert module). In principle, ITSs may mimic or even exceed the behavior of the best teachers. This potential, however, has never been fully realized in practice.

The situation today remains much as it has (been). The central importance of the content domain, modeling the student and the interactions between them remain as before. Every automated instructional system consists of: a) one or more learners, human and/or automated, b) content to be acquired by the learners, also known as knowledge representation (KR), c) a communication or “display” system for representing how questions and information are to be presented to and received from learners, and d) a tutor capable of deciding what and when information is to be presented to the learner and how to react to feedback and/or questions from the learner.

A major bottleneck in the process has been representation of the content domain (expert model). As Psotka et al (1988, p. 279) put it, The fundamental problem is organizing knowledge into a clear hierarchy to take best advantage of the redundancies in any particular domain. Without extensive experience in doing this, we are largely ignorant of the kind of links and predicates to use. We are still far from cataloging the kinds of links needed for these semantic hierarchies. The best predicates that might describe these knowledge structures simply, beyond ISA and PART OF hierarchies, still need to be defined. Too little work has been aimed at developing new representations for information and relationships. He goes on to mention the need to consider OO frameworks and/or structures containing objects, relationships and operations (pp. 279-280).

A variety of approaches to Knowledge Representation (KR) have been used in ITS development. Among the earliest are Anderson's ACT-R theory (e.g., 1988) based on productions systems and Scandura's Structural Learning Theory (SLT) and the closely associated method of Structural (Cognitive Task) Analysis (SA) (e.g., Scandura, 2001 a). Both production systems and procedures in SLT are fully operational in the sense that they can be directly interpreted and executed on a computer. Other popular approaches are based on semantic/relational networks of one sort or another (e.g., knowledge spaces, conceptual graphs). Semantic networks represent structural knowledge hierarchically in terms of nodes and links between them. Semantic networks have the benefit of representing knowledge in an intuitive fashion. Unlike production systems and SLT procedures, however, they are not easily interpreted (executed on a computer). In effect, each type of representation has important advantages and limitations: Production systems are operational but do not directly reflect structural characteristics of the knowledge they represent. Networks represent the structure but are not directly operational. It also is worth noting that most approaches to KR make a sharp distinction in the way they treat declarative and procedural knowledge, on the one hand, and domain specific and domain independent knowledge, on the other.

Given the complexity of current approaches, a variety of tools have been proposed to assist in the process. Most of these are tailored toward one kind of content or another. Merrill's ID2 authoring software (http://www.id2.usu.edu/Papers/ID1&ID2.PDF), for example, offers various kinds of instructional transactions, each tailored to a specific kind of knowledge (e.g., facts, concepts or procedures). Such systems facilitate the development of instructional software but they are limited to prescribed kinds of knowledge. In particular, they are inadequate for delivering instruction where the to-be-acquired knowledge involves more than one type, as normally is the case in the real world.

Such tools can facilitate the process. However, the problem remains that there have been no clear, unambiguous, universally applicable and internally consistent methods for representing content (expert knowledge). In the absence of a generalizable solution to this problem, ITS development has been largely idiosyncratic. The way tutor modules interact with student models as well as the human interface through which the learner and tutor communicate have been heavily dependent on the content in question. The widespread use of production systems (e.g., Anderson, 1988) for this purpose is a case in point. Production systems have the theoretical appeal of a simple uniform (condition-action) structure. This uniformity, however, means that all content domains have essentially the same structure—that of a simple list (of productions). In this context it is hard to imagine a general-purpose tutor that might work even reasonably (let alone equally well) with different kinds of content. Without a formalism that more directly represents essential features, it is even harder to see how production systems might be used to automate construction of the human interface.

Representations focused on OO inheritance are limited in its emphasis on objects, with operations subordinate to those objects. Representing rooms, car and clean operations, for example, involves talking about such things as room and car objects cleaning themselves, rather than more naturally about operations cleaning rooms and cars (e.g., Scandura, 2001b).

Consequently, ITSs have either been developed de novo for each content domain, or built using authoring tools of one sort or another designed to reduce the effort required (e.g., by providing alternative prototypes, Warren, 2002). Whereas various industry standards (e.g., SCORM) are being developed to facilitate reuse of learning objects (e.g., diagnostic assessments and instructional units) in different learning environments, such standards are designed by committees to represent broad-based consensus. Cohesiveness (internal consistency) and simplicity are at best secondary goals. Specifically, such standards may or may not allow the possibility of building general-purpose tutors that can intelligently guide testing (diagnosis) and instruction based solely on the structure of a KR without reference to semantics specific to the domain in question. They do not, however, offer a solution to the problem.

A recent article on the Structural Learning Theory (SLT) outlines an approach to this problem (Scandura, 2001a). SLT was designed from its inceptions explicitly to address interactions between the learner and some external agent (e.g., observer or tutor), with emphasis on the relativistic nature of knowledge (e.g., Scandura, 1971, 1988). The former articles (i.e., Scandura 2001a,b) summarize the rationale and update essential steps in carrying out a process called Structural (cognitive task) Analysis (SA). In addition to defining the key elements in problem domains, and the behavior and knowledge associated with such domains, special attention is given to the hierarchical nature of Structural Analysis, and its applicability to ill-defined as well as well-defined content. Among other things, higher order (domain independent) knowledge is shown to play an essential role in ill-defined domains. SA also makes explicit provision for diagnostic testing and a clear distinction between novice, neophyte and expert knowledge. While broad, however, this overview omits essential features as well as the precision necessary to allow unambiguous automation on a computer.

Although incomplete from the standpoint of ITS, parallel research in software engineering provides the necessary rigor as far as it goes. This research makes very explicit what has until recently been an informal process (of SA). SA has evolved to the point where it is automatable on a computer (U.S. Pat. No. 6,275,976, Scandura, 2001b) and sufficient for representing the knowledge not only associated with domain specific content but also with domain independent knowledge and ill-defined domains.

A recent article by Scandura (2003) extends this analysis to domain specific systems of interacting components and shows how the above disclosure ((U.S. Pat. No. 6,275,976) provides an explicit basis for representing both declarative and procedural knowledge within the same KR. While abstract syntax tree (ASTs) are used for this purpose in the preferred embodiment it is clear to anyone skilled in the art, that any number of formal equivalent embodiments might be used for similar purposes. ASTs, for example, are just one kind of representation of what is commonly referred to as Knowledge Representation (KR).

Programming is inherently a bottom-up process: the process of representing data structures and/or processes (a/k/a to be learned content) in terms of elements in a predetermined set of executable components. These components include functions and operations in procedural programming and objects in OO programming. Software design, on the other hand, is typically a top-down process. Instead of emphasizing the assembly of components to achieve desired ends, the emphasis is on representing what must be learned (or executed in software engineering) at progressive levels of detail.

Like structured analysis and OO design in software engineering, structural analysis (SA) is a top-down method. (Whereas processes and data are refined independently in structured analysis and in OO design, both are refined in parallel in SA.) However, it is top-down with a big difference: Each level of representation is guaranteed to be behaviorally equivalent to all other levels. The realization of SA in AutoBuilder also supports complementary bottom-up automation. Not only does the process lend itself to automation, but it also guarantees that the identified competence is sufficient to produce the desired (i.e., specified) behavior.

The present disclosure is based on the commonly made assumption that any instructional system consists of one or more learners, human and/or automated, and a representation of the content to be taught. The latter represents the knowledge structure or structures to be acquired by the learners and may be represented in any number of ways. Also assumed is an electronic blackboard or other means of presenting information to and receiving responses from learners. Either the learner or an automated tutor must decide what and when information is to be presented to the learner and/or how to react to feedback from the learner.

### SUMMARY OF THE INVENTION

The disclosed methods provide a new more efficient and reliable way to develop and deliver a broad range of computer based learning systems, ranging from simple practice to highly adaptive intelligent tutoring systems, with essentially any content.

Instructional systems are assumed to include one or more learners, human and/or automated, content, means of presenting information to and receiving responses from learners, and an automated tutor capable of deciding what and when information is to be presented to the learner and how to react to feedback from the learner.

This invention discloses methods for representing and making observable essentially any kind of to-be-acquired knowledge and methods, which do not depend on the kind of knowledge, for delivering that knowledge to learners. Specifically, these methods reveal:

1. How to model behavior and associated knowledge i.e., how to represent the kinds of problems to be solved and the knowledge to be acquired. To be acquired behavior (demonstrating the ability to solve problems) and knowledge (making it possible to solve such problems) are represented as executable Abstract Syntax Trees (ASTs), represented at multiple levels of abstraction. In the preferred embodiment, ASTs have two essential advantages: Like production systems they are fully operational and like networks they directly reflect structural characteristics of the knowledge they represent. Semantic attributes assigned to nodes in said ASTs provide supplemental information useful in diagnosis and instruction. Semantic attributes also make it possible to define the learner model, indicating what individual learners do and do not know both initially and at any subsequent point in time. Display properties assigned to nodes in problem ASTs define how information is to be represented in an observable interface to learners and how to receive responses from learners. A wide variety of diagnostic and tutoring options provide constraints on learner and/or automated tutor control of the learning environment. Display attributes also may be assigned to nodes in knowledge AST, and may be used to provide learners with more control over their learning environment.

2. How, given an AST representation of the behavior and knowledge to be acquired, to make all learning and tutoring decisions (e.g., sequencing, generation of specific problems) automatically based solely on the learner model and structural characteristics of ASTs but without reference to specific content.Various kinds of diagnosis, instruction, simulation and practice may be authorized, including learner and/or automated tutor control. The methods apply to all kinds of knowledge, declarative as well as procedural and domain specific as well as domain independent. They also provide for different levels of learning, ranging from highly automated knowledge to the ability to use acquired knowledge to solve problems.

Although others skilled in the art will find alternative ways to utilize these methods, the preferred embodiment is in accordance with the inventor's Structural Learning Theory (e.g., Scandura, 2001a), Structural (Cognitive Task) Analysis (e.g., Scandura, 2003), U.S. Pat. No. 6,275,976 (Scandura, 2001a) and Scandura.com's AutoBuilder software (www.scandura.com).

### BRIEF DESCRIPTION OF DRAWINGS

FIG. 1. AST Tree view representing the input-output behavior. In addition to the minus sign and an underline, the column subtraction problem (represented as Prob) is defined as a set (any number) of columns, each with seven components. In addition to type of refinement (e.g., Prototype, Component), this tree view distinguishes those values having relevance to learning (i.e., abstract values such as ‘Done’, ‘NotDone’ and Subtracted’, ‘NotSubtracted’. For example, Prob can be ‘Done’ or NotDone’ and CurrentColumn can be ‘Subtracted’ or NotSubtracted’. This tree view also includes information under INPUT pertaining to Parent-Child mappings and under Output to Input-Output mappings. For example, the Parent-Child mapping <{all}Subtracted; Done> means that the parent ‘Prob’ is ‘Done’ when all of the columns have been ‘Subtracted’. Similarly, the INPUT value of ‘Prob’ may be “Done’ or ‘NotDone’ but the OUTPUT must be “Done’.

FIG. 2. A Flexform knowledge AST representing all levels of abstraction of the process of column subtraction. Higher levels of abstraction in the Flexforms are separated from their children by dotted lines. Each node in the AST is assumed to be executable, either directly or in terms of lower level (e.g., terminal) nodes that are executable.

FIG. 3. The top two levels of the Flexform representing, respectively, ColumnSubtraction as a whole and the REPEAT . . . UNTIL loop in which each column is subtracted in turn.

FIG. 4. Flexform showing terminal operations in the Flexform.

FIG. 5. Flexform AST representing the Signal component. It receives one of two events (train ‘in’ the crossing and train ‘out’ of crossing). In the former case it sends a ‘red’ signal to Gatel in the latter case it sends a ‘green’ signal.

FIG. 6. Dialog box showing abstract values of a simulated Railroad Crossing system and the train, signal and gate components in this system and their abstract values. The dialog also shows portions of the declarative knowledge representing the relationships between the components and the system as a whole (e.g., a working system consisting of the train being in [the station], the signal being red and the gate being down).

FIG. 7. Dialog box defining the kind of interface to be used for the Gate component. Dialog boxes are optional and used only where the system's behavior is to be simulated. In this case, the interface is the default dialog used in Scandura's SoftBuilder software, which represents essentials without any customization.

FIG. 8. Dialog box in the preferred embodiment showing sample semantic attributes assigned to AST nodes.

FIG. 9. Dialog box in the preferred embodiment showing layout of a column subtraction problem. The Bottom digit in the Tens column is highlighted both in the treeview on the left side and the Blackboard layout on the right.

FIG. 10. Dialog box in the preferred embodiment showing how observable properties are assigned to individual variables. The ‘Bottom’ variable in the position x =216, y=111 has been assigned the value 3. ‘Path’ replaces ‘Value’ when a file reference is required (e.g., Flash .swf, Sound. wav). Geometric displays, such as Line and Rect, have no Value, only coordinates. Text may be rotated and a specific Number of Characters may be assigned to textual (learner) responses. Semantic attributes representing QUESTIONS, INSTRUCTION, etc. (see FIG. 8) may be assigned properties in a similar manner. Other properties that may be assigned include: a) whether or not to ignore a variable when testing for automation (of the knowledge defined by a subtree containing that variable) and b) whether the named variable has a constant value meaning that its value (as well as its name) should be taken into account in determining whether or not a knowledge AST applies to the problem in which the constant variable is a part.

FIG. 11. Pictures (bmp files) associated with abstract values of child components in the crossing system. The treeview includes all combinations of these values. The Blackboard on the right side displays those pictures last selected in the tree view.

FIG. 12. Definition of a project level problem solvable using the Signal component in the Crossing system.

FIG. 13. Definition of a project level problem, whose solution requires all three components in the Crossing system.

FIG. 14. Dialog box showing Tutor Options in the preferred embodiment Each TutorIT Delivery Mode is defined by various combinations of the options below the delivery mode. For example, ADAPTIVE must include both diagnosis and tutoring. These as well as non-mandatory options may be set as desired and saved so they can later be used by the Universal Tutor (see below). Notes on Delivery Modes and Strategies at the bottom of the figure illustrates the wide range of possibilities.

FIG. 15. Dialog box showing the information necessary to construct a representation of factual knowledge of state capitals in the USA.

FIG. 16. A specific column subtraction problem derived from the original problem type such as that shown in FIG. 9.

FIG. 17. A column subtraction problem derived from a non-terminal node the original problem type such as that shown in FIG. 9. Specifically, the node involves borrowing, and involves executing three distinct terminal nodes: crossing out, entering the reduced top digit and adding one ten to the top digit in the one's column.

FIG. 18. Shows a learner's status on nodes in column subtraction.

### DETAILED DESCRIPTION

Modeling Behavior and Associated Knowledge: The present disclosure assumes that any behavior that a learner is to acquire can be represented as an abstract syntax tree (ASTs) with semantic attributes (e.g., Scandura (2003). For example, behavior may be specified in terms of ASTs representing given and goal data structures in problems to be solved. Knowledge also can be represented in terms of ASTs. The major difference is that knowledge ASTs (e.g., computer programs) are assumed to be executable on a computer, whereas problem (behavior) ASTs represent data structures on which knowledge ASTs operate.

In the present disclosure, the behavior a learner is to acquire can be specified in terms of problem ASTs. Problems represent the behavior to be acquired, wherein said problems consist of initialized input (Given) and output (Goal) AST data structures. Each level in a problem hierarchy represents equivalent behavior at a different level of abstraction. Knowledge consists of input-output data structures and hierarchies of operations for generating outputs from the inputs. In the preferred embodiment, these operations represent procedural knowledge at different levels of abstraction. Input-output knowledge structures are like formal parameters in software, whereas problems represent the actual data on which knowledge operates. In the preferred embodiment, parent-child mappings between elements in said input-output data structures represent declarative knowledge.

There is a close relationship between Given and Goal ASTs in Problems and Input and Output data structure ASTs (sometimes loosely called Behavior ASTs) representing declarative knowledge. The latter, for example, provide a general format from which any number of specific problems may be derived. In the preferred embodiment, this relationship is provides a convenient means of constructing problems from input and output data structures.

Anyone skilled in the art will also recognize that Knowledge ASTs may themselves act as data. In the preferred embodiment, higher order knowledge, which is often domain independent, may act on and/or generate (new) Knowledge ASTs (e.g., U.S. Pat. No. 6,275,976, Scandura, 2001; Scandura, 2003).

Hierarchies and Atomicity.—As any one skilled in the art knows, ASTs may be represented in any number of formally equivalent ways (e.g., hierarchies, networks, production systems). For example, grammar productions are widely used to define programming languages, and effectively to represent programs written in those languages hierarchically. In the preferred embodiment, ASTs are represented as hierarchies in which terminal nodes are atomic elements or operations. In the case of behavior, atomic elements represent essentials of the behavior those observables that make a difference (e.g., to the learner and/or tutor). In the case of knowledge, atomicity refers to prerequisite elements in a representation that may be assumed either known by a population of learners in their entirety or not at all. Atomicity is closely associated with the notion of abstract values (Scandura, 2003), and has long played a central role in instructional theory. In essence, atomic elements are those that make a difference in behavior and to-be-acquired knowledge.

Behavior and knowledge at each level in an AST need not be identical, but it is important that each level be equivalent. Specifically, equivalence depends on what are called abstract values (Scandura, 2003). Only certain distinctions are important from a learning and instructional perspective. For example, while it is important to distinguish individual digits (0, 1, 2, . . . 9) in learning the addition facts (e.g., 3+8=11). On the other hand, in the addition algorithm it is sufficient to simply add individual digits (without distinguishing which digits). The relevant distinctions pertain to such things as knowing when to carry and when not. Each such distinction represents a partition on possible values, and is called an abstract value. In general, these abstract values represent important categories (equivalence classes) that are important from a behavioral perspective—to decisions that must be made in carrying out the algorithm.

Structural Analysis and ASTKnowledge Hierarchies.—It is well known that a variety of knowledge engineering methods may be used to construct AST hierarchies that are executable on a computer. In the preferred embodiment, however, instructional designers and domain/subject matter experts use Structural (cognitive task) Analysis to represent to-be-acquired knowledge ASTs as Flexforms. Structural Analysis can be performed on essentially any task domain, including both domain-specific and domain independent knowledge (U.S. Pat. No. 6,275,976, Scandura, 2001; Scandura, 2003). Both input-output behavior (as we shall see, declarative knowledge) and underlying cognitive processes (to be learned procedures) are specified in a clear unambiguous manner basic method consists of representing the input-output behavior and/or procedural knowledge in question at a high level of abstraction and refining that input-output behavior and procedural knowledge progressively until some predetermined level of detail is obtained (see atomicity above).

The result of structural analysis is not necessarily executable directly—that is, representable in a language understandable to the computer. (Contrast this with software engineering, in which equivalence in a design hierarchy normally refers to actual behavior. While the operations in a program (e.g., in structured analysis) may be represented hierarchically, the operations at each level of abstraction in the design hierarchy normally operate on the same data. To say that the behavior is equivalent in this case is essentially a tautology.) In software engineering, equivalence requires that each level in the hierarchy produces identical behavior. This means that behavior of the parent operation is identical to that of its children taken collectively. One may envision the hierarchy as being composed of progressively simpler subroutines in which the parent subroutine in each case produces the same behavior as its child subroutines. In general, it is extremely difficult to prove that the behavior of the parent in a refinement and that of its children is identical. (There is no general solution to this problem: Each an every different refinement requires a separate proof and is quite impractical, e.g., see Scandura, 2003.) What is essential is that the resulting AST represent what is essential for purposes of learning and instruction. Accordingly, the process of Structural Analysis results in an AST input-output data (behavior) hierarchy in which each level of abstraction in the AST represents behavior. In an AST procedural knowledge hierarchy, Structural Analysis similarly results an AST in which each level of abstraction in the AST represents equivalent knowledge. The only difference is the degree of abstraction at each level.

Scandura (U.S. Pat. No. 6,275,976; Scandura, 2003) has identified a small number of refinement types based on the fact that every refinement can be represented either as a category or as a relationship between elements. Table 1 is adapted from Scandura (2003) and lists variants of those basic refinement types that play an important role in representing input-output behavior and procedural knowledge (as well as software specifications and designs generally). Table 1 also indicates that each behavioral variant corresponds to a unique procedural variant, one guaranteeing that the children in a refinement generate the same behavior as the parent. In effect, the kind of process or procedural refinement necessary to assure equivalence depends on how the input-output data (associated with the parent) is refined.

For example, the parent in a Component refinement (where the input variable is refined into a set of independent elements) calls for a Parallel refinement, in which each child element may be operated on independently and still generate equivalent behavior. In this case, the parent variable is an input variable in the parent operation in the knowledge AST. The child operations necessarily operate on elements in the children in the component refinement. Similarly, in a Prototype refinement a single child represents a number of elements having the same structure. The corresponding Knowledge representation in this case is a Loop (e.g., WHILE . . . DO, REPEAT . . . UNTIL) or Navigation Sequence (e.g., operate on the last element in a set). In effect, a loop is used when the number of child elements is variable and a Navigation Sequence when the number of child elements is fixed.

Category refinements, in turn, correspond to a selection (e.g., CASE or IF . . . THEN) refinement when the children in the Category are terminal. When the children in a Category refinement are themselves structures (as in a class hierarchy), then the procedural refinement is an abstract operation operating on that class of objects. The “affiliate” mechanism used by abstract operations to generate behavior is defined in Scandura (2001b).

Dynamic refinements involve defining a parent variable as an operation having its own inputs and outputs. Consider the parent variable “clean”, or any other action variable for that matter. The only way such a variable can be made more [precise (i.e., refine it) is by defining it as an operation with its own input and output variables. When such a variable is the parameter of parent operation, the child operation interacts with the parent. For example, “callback” in the operation

display_dialog (callback, persistent_variables)

is refined as an operation which interacts with the persistent_variables, which uses them as both input and output.

The special variants, component, category and dynamic, while not exhaustive, have simple procedural counterparts, which collectively are sufficient for automatically refining a broad variety of Input-Output behaviors. Remaining examples of relational refinements (i.e., Definition—>varied procedural code) and category refinements (i.e., Terminal>Case) cover the remaining cases and make it possible to represent any given Input-Output behavior or procedure with any desired degree of precision. The essential is that each refinement must be internally consistent, wherein behavior associated with each parent (behavior or operation) is equivalent to that of its children.

TABLE 1

| | |
|---|---|
| Specification/Input-Output | Design/Procedural Refinement |
| Behavior Refinement | |
| Definition [non-hierarchical | Sequence, Selection, Loop w/ |
| relation] | operations determining the relation |
| Component [is an element of] | Parallel |
| Prototype (variable # | Loop (repeat-until, do-while) |
| components) | [introduces variable alias] |
| Prototype (fixed # components) | Navigation sequence [introduces fixed |
| | aliases] |
| Category [is a subset of] | Abstract Operation |
| Category (atomic sub- | Selection (case/if-then, based on |
| categories) [is a subset] | sub-categories) |
| Dynamic (variable refined into | Interaction (e.g., dialog with callback) |
| operation) | |
| Terminal | Case (based on abstract values) |

Abstract Equivalence. Demanding exact equivalence of parent and child behavior is impractical (see footnote 7). In contrast, the methods revealed herein are quite practical because equivalence is based on abstractions, specifically on equivalence classes of values called abstract values (see Scandura, 2003, U.S. Pat. No. 6,275,976). Furthermore, rather than refining only data (as in data analysis) or process (as in structured analysis), both data and processes in the preferred embodiment are refined in parallel. More precisely, equivalence in a refinement is defined in terms of abstract behavior defined by the top and bottom paths in a refinement. A refinement is said to be abstractly consistent if starting from the inputs to the child operations, the abstract behavior generated by the top path (child-parent mapping followed by the parent's input-output behavior) is equivalent to the bottom path (abstract input-output behavior of the children followed by the parent-child mappings). An AST is said to be internally consistent if each refinement in the AST is equivalent.

To summarize, Structural Analysis results in rigorously defined, internally consistent Abstract Syntax Tree (AST) representations of to-be-learned Input-Output behavior and/or procedural knowledge. Input-Output behavior ASTs are internally consistent in the sense that the abstract behavior parent behavior in each refinement is equivalent to that of its children. Such equivalence is defined in terms of both input-output and parent-child mappings. Corresponding procedural knowledge ASTs are internally consistent because constraints imposed on each type of knowledge refinement (e.g., Parallel, Selection) guarantee that the abstract behavior defined by the parent and child operations is equivalent.

Procedural and Declarative Knowledge. ASTs define two kinds of knowledge and corresponding behavior. Procedural knowledge and the associated behavior are defined in terms of input-output behavior. Declarative knowledge, on the other hand, is operationalized (made executable) in terms of parent-child mappings in Input-Output Knowledge ASTs. In effect, ASTs make it possible to detect both procedural and declarative knowledge both result in observable behavior (e.g., Scandura, 2001).

Procedural knowledge, however, may be arbitrarily complex. In knowledge ASTs, each procedure node represents a separate operation, each with its own input and/or output variables. In contrast, declarative knowledge is direct. Declarative knowledge is defined by atomic parent-child mappings between parent nodes and their children.

In preferred embodiment, procedural knowledge (i.e., each operation in a procedural AST) is operationalized in terms of executable operations capable of generating Input-Output behavior. Correspondingly, declarative knowledge is operationalized in terms of executable Parent-Child mappings in Input-Output data structures (representing hierarchies of formal parameters). Both procedural and declarative knowledge can be represented as above at various levels of abstraction, with higher level operations defined in terms of (terminal) executables. In preferred embodiment, each level of abstraction is equivalent in the sense revealed in Scandura (U.S. Pat. No. 6,275,976, 2001; 2003).

As we shall see below, nodes in knowledge ASTs may be assigned semantic attributes pertaining to learning and tutoring processes. Such nodes also may be assigned display properties (see below) making them observable to learners.

Knowledge Structure and Executability. Whereas anyone skilled in the art can devise any number of formally equivalent ways to represent ASTs, the above analysis establishes two essential facts: a) Said ASTs directly reflect structural characteristics of the knowledge they represent. b) Said ASTs are fully operational.

Like networks and conceptual frameworks, for example, ASTs clearly represent the structure of the knowledge they represent. Moreover, individual ASTs represent knowledge (as well as behavior) at all possible levels of abstraction. Production systems, on the other hand, consist of lists of unrelated condition-action pairs. Structural relationships in production systems are NOT directly represented. Relationships among the productions in a production system can only be determined as a result of execution. In effect, such relationships consist entirely of the orders in which they are executed in solving particular problems.

Like production systems, ASTs, in which nodes represent operations or conditions (functions) and/or in which parent-child mappings have been defined (e.g., in terms of abstract values), also are executable. Specifically, in the preferred embodiment, each node in said ASTs is an operation or condition (function), or an operational parent-child mapping.

The refinement process is continued until each terminal operation in an AST is atomic. Since atomicity does not always mean executable, said terminal operations ultimately must be implemented in some computer language. This issue is addressed in the preferred embodiment by use of a high level design language, which not only includes a broad array of relevant executables (e.g., operations and functions), but which also is easily extensible.

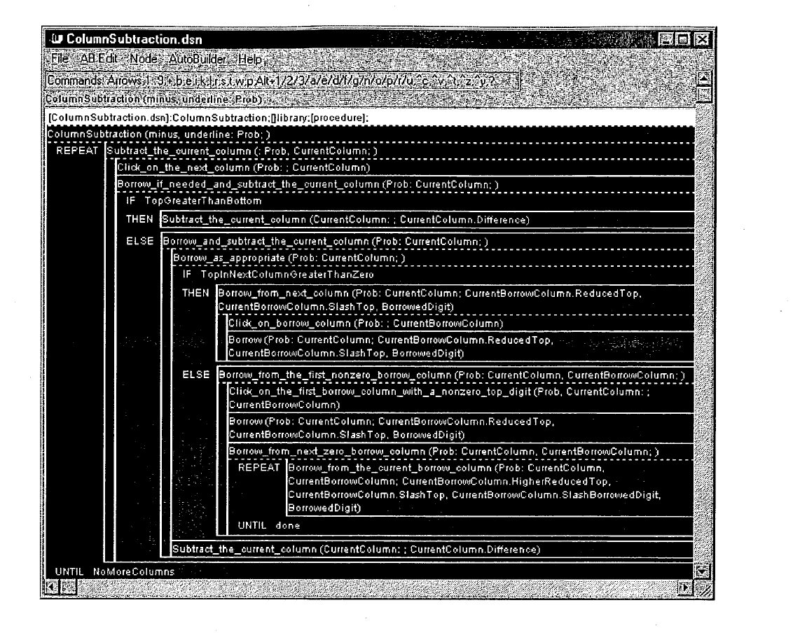

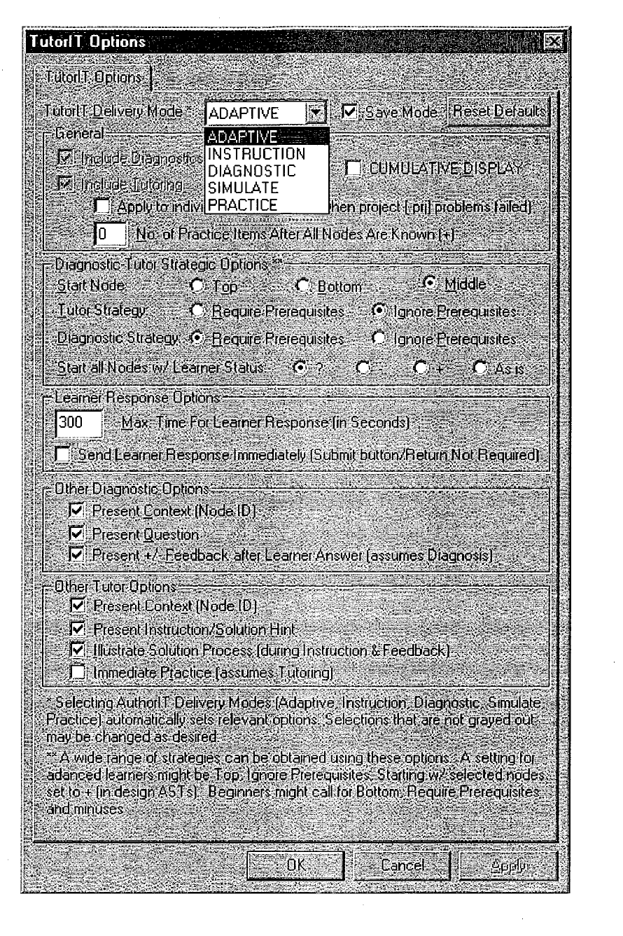

Consequently, said ASTs can be executed directly. Each node in said tree may be executed in turn by traversing nodes in each AST in a top-down depth-first manner (as is the case with most interpreters). During a traversal, individual nodes may or may not be executed depending on constraints imposed on the traversal. For example, rather than executing behavior directly associated with a non-terminal node, one might execute all of the terminal nodes defined by the subtree defined by that non-terminal. Thus, borrowing in column subtraction involves comparing top and bottom digits, borrowing from the next column and adding the ungrouped ten in the current column (see FIG. 2). Similarly, one might decide whether or not to test or provide tutoring on a node, depending on the current state of the learner model (representing the learner's current knowledge). The options may vary widely, and in the preferred embodiment are available as options (see FIG. 14 for specifics in the preferred embodiment). FIG. 14 does not show an option for allowing learner control as to what node to choose and/or the kind of instruction. Nonetheless, learner control does play a key role in the preferred embodiment.

Parent-child mappings play an essential role in representing declarative knowledge in systems of interacting components (commonly called “models”), specifically in representing relationships between the components (see Scandura, 2003 and section below on Model-based Behavior and Knowledge ). In the preferred embodiment, which is based on the Structural Learning Theory (U.S. Pat. No. 6,275,976, Scandura, 2001), procedural ASTs may serve as data to higher order knowledge ASTs. In this case, Parent-Child mappings in procedural ASTs also may be used to represent declarative knowledge. For example, refining condition nodes (nodes representing conditions) in procedures (i.e., representing conditions more precisely) necessarily involves relationships. For example, in FIG. 2, the condition “TopGreaterThanBottom” necessarily involves a relationship between top digit and bottom digit, namely “top =bottom”, or its negation “not (top<bottom)”.

Similarly, knowing that “Borrow_if_needed_and_subtract_the_current_column”” involves “Borrow_as_appropriate” followed by “Subtract_the_current_column” represents declarative knowledge. Parent-child mappings in this case are determined by consistency rules designed to insure that the parent and child operations produce the same or equivalent behavior (e.g., see U.S. Pat. No. 6,275,976, Scandura, 2003). Another example is knowing that “Borrow_as_appropriate” in FIG. 2 involves checking to determine whether “TopInNextColumnisGreaterThanZero” followed by “Borrow_from_next_column” or Borrow_from_the_first_nonzero_borrow_column”, depending on whether the answer is positive or negative. In short, when procedural ASTs serve as data (to higher order knowledge ASTs), parent-child relationships in those procedural ASTs represent declarative/relational knowledge in an operational way that can be tested—for example, by having a learner describe (or select) the parent given the children or vice versa.

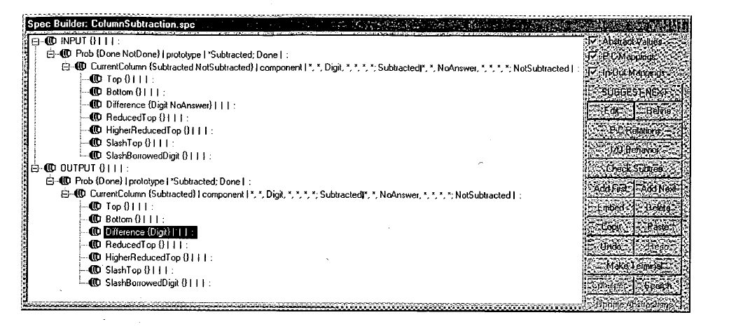

Input-Output Data Structures in Knowledge ASTs.—FIG. 1 represents the input-output data structures associated with Column Subtraction. Abstract values in this figure represent essential differences before and after mastery (i.e., execution). For example, CurrentColumn may be Subtracted or NotSubtracted when it serves as INPUT but only Subtracted as OUTPUT. While those skilled in the art might devise any number of equivalent AST representations, FIG. 1 is a familiar tree-view. In addition to a minus sign and an underline, every column subtraction problem (represented as Prob) is defined as a set (any number) of columns, each with seven components. The refinement consisting of Prob and its child CurrentColumn is a “prototype” refinement (U.S. Pat. No. 6,275,976; Scandura, 2003). In turn, CurrentColumn is refined into a Top digit, a Bottom digit, Difference digit and so on. The other components (e.g., ReducedTop, SlashTop) represent variables whose values must be determined in the course of solving a subtraction problem.

In addition to type of refinement, this tree view distinguishes those values having relevance to decision making during learning (i.e., abstract values). For example, Prob can be “Done” or “NotDone and CurrentColumn can be “Subtracted” or “Not Subtracted”. ”. This tree view also includes information under INPUT pertaining to Parent-Child mappings and under OUTPUT to Input-Output mappings. For example, the Parent-Child mapping<*Subtracted; Done> means that the parent “Prob” is “Done” when all of the columns have been “Subtracted”. Similarly, the INPUT value of “Prob” may be “Done” or “NotDone” but the OUTPUT must be “Done”.

These mappings insure that each level of abstraction in FIG. 1 represents the same or equivalent behavior. In column subtraction, the variables Top and Bottom (in each column) under INPUT would be assigned a specific digit (i.e., be a initialized variable). The goal would be to determine the corresponding values of Difference under OUTPUT (and in the process of solving the problem, the intermediate values of ReducedTop, HigherReducedTop, etc.). The only difference is the degree of abstraction at each level of refinement.

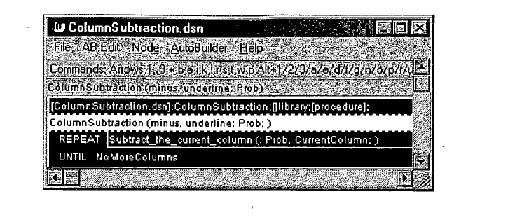

Procedures in Knowledge ASTs.—FIG. 2 is a Flexform AST representing the process of column subtraction at all levels of abstraction. Higher levels of abstraction in the Flexforms are separated from their children by dotted lines. FIG. 3, for example, shows only the top two levels: Respectively, these represent ColumnSubtraction as a whole and the REPEAT . . . UNTIL loop in which each column is subtracted in turn.

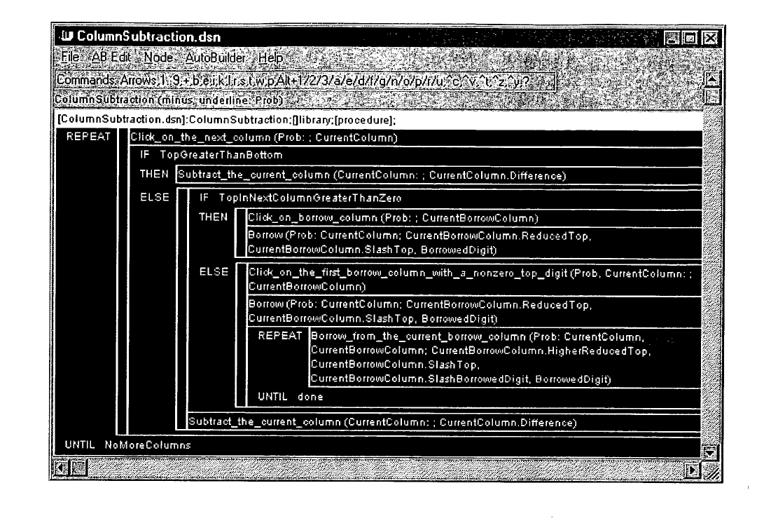

FIG. 4 shows only terminal levels in the same Flexform. In this AST, all terminal operations (e.g., Subtract_the_current_column, Borrow) are assumed to be atomic. In particular, the terminal operation Subtract_the_current_column (CurrentColumn:; CurrentColumn.Difference) is atomic implying that the learner has mastered (all of) the basic subtraction facts. Knowledge of these facts (like all terminal operations) is assumed to be all or none. In general, basing instruction on this representation assumes that the learner has mastered all of these (terminal) prerequisites. If an instructional designer were unwilling to make this assumption with respect to any given terminal operation, then he would be obliged to refine this operation further. Refinement would continue until all terminal operations may be assumed atomic with respect to the target learner population. In the case of Subtract_the_current_column, one possibility might be to distinguish “harder” facts (e.g., 17-9, 13-6) from simpler ones (e.g., 4-2, 5-3). Another would be to consider each separate fact atomic. In either case, terminal operations used in Flexform AST by definition constitute prerequisite knowledge, knowledge that is either known completely or not at all. A long series of empirical tests provide unusually strong support for this assumption, and its broad applicability (Scandura, 1971, 1977).

As above, consistency in a Behavioral (Input-Output data structure) AST depends on abstract equivalence of top and bottom paths. As first revealed in U.S. Pat. No. 6,275,976, abstract equivalence in procedural knowledge ASTs is based on consistency constraints (Scandura, 2001a, 2003). Equivalence in Knowledge ASTs can be used to represent essentially any kind of knowledge. These constraints are designed to insure that abstract behavior of the parent and child operations in a procedural Knowledge (aka design) AST will be equivalent if certain constraints are satisfied.

AST Factual and case-based knowledge, for example, are special cases of procedural knowledge. Factual knowledge, for example, can be represented in at least two ways. First, each fact (e.g., 11−6=?) can be represented as a problem to be solved with a common solution procedure for generating the answer to each [e.g., subtract (top, bottom:, difference)]. In this case, the facts represent desired behavior and the subtract operation, knowledge that might be used to generate that behavior. Second, each fact itself can be represented as a separate knowledge AST (e.g., 11−6=5), each fact defining its own problem/behavior (e.g., 17−6=?). The former embodiment more readily lends itself to representing more complex knowledge (see below) in which one or more Knowledge ASTs may be used to solve given problems.

The second method distinguishes the knowledge (ASTs) used for each factual behavior. This method is more convenient when one wants to teach each fact individually. Indeed, it is possible to gain the benefits of both methods by representing each problem and item of factual knowledge individually. In this case, individual problems are solved by selecting from available knowledge ASTs (i.e., the facts). This preferred embodiment is consistent with the inventor's Structural Learning Theory (e.g., Scandura, 2001a). Specifically, the control mechanism first formalized and revealed in U.S. Pat. No. 6,275,976 provides an automatable and universally applicable method for selecting knowledge ASTs. Given any problem, this mechanism tells what knowledge AST to use and when to use it even when any number of knowledge ASTs may be required in the solution.

Case-based (conceptual) knowledge (e.g., distinguishing animals) is represented similarly. The main difference is that the each concept (e.g., cat, dog) corresponds to selector in a CASE refinement.

Clearly, a broad range of behavior can be subsumed under procedural knowledge. The distinguishing characteristic of procedural knowledge is that behavior can be generated by combining the Input-Output behavior of simpler knowledge (constructed via the various kinds of refinement identified in Table 1). In the preferred embodiment, however, behavior is represented by mappings between parent nodes and their children in ASTs as well as by mappings between input output nodes. We shall see below how the first kind of (Parent-Child) mapping provides an explicit basis for declarative behavior and declarative knowledge.

Parent-Child Mappings and Declarative Knowledge. Input-output behavior associated with operations in procedural ASTs and parent-child behavior associated with mappings in data structures in such ASTs represent two quite different kinds of knowledge: Input-output mappings represents procedural knowledge; parent-child mappings represent declarative knowledge (Scandura, 2003). Although any AST may include both types of knowledge, these kinds of knowledge are frequently separated in both theory and practice. With the exception of the inventor's Structural Leaning Theory, for example, each type of knowledge is represented quite differently in cognitive and instructional theories. The above analysis clearly shows that both kinds of knowledge may be represented in single internally consistent AST representations.

In particular, Parent-Child mappings in ASTs represent declarative behavior and the associated mappings represent declarative knowledge. Parent-Child mappings, however, are NOT generally decomposed. Unlike procedural knowledge, declarative knowledge is necessarily direct: Parent-child mappings and the corresponding knowledge (for generating that behavior) are essentially the same—although it should be noted that declarative relationships between multiple levels of refinement in an AST may be represented in terms of successive Parent-Child mappings (those associated with each level involved).

Declarative knowledge may include anything from simple declarative knowledge to multi-level relationships in complex models of interacting systems. Knowledge that cats and dogs are animals and that jogging, walking and running are means of movement are simple examples of declarative knowledge. In these cases, the parents would be animals and means of movement, respectively. The children, respectively, would be cats and dogs, and jogging, walking and running.

Model-based Behavior and Knowledge. To-be-acquired knowledge is frequently classified as being either procedural or declarative in nature. As shown in Scandura (2003), however, knowledge (e.g., domain-specific models) may include both kinds. Specifically, systems of interacting components, often called models, involve both declarative and procedural knowledge.

The Railroad Crossing model below taken from Scandura (2003) illustrates includes both declarative and procedural knowledge.In this case, the top-level refinement defines the Parent-Child mappings between a Crossing and its components, Train, Signal and Gate. These mappings represent declarative knowledge. The behavior of the Train, Signal and Gate, however, which interact in the crossing, is procedural in nature. Indeed, the behavior associated with these independent procedures may be combined to solve more complex problems (i.e., to produce behavior that requires use of more than one procedure).

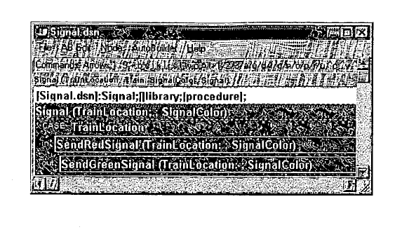

In order for the crossing system to operate correctly, these components interact as follows: As the train approaches the crossing, the signal detects its proximity and sends a message (SignalColor is red) to the gate. The gate detects the red color and moves the gate down. Conversely, when the train leaves the crossing, the signal detects that fact and tells the gate to go up. FIG. 5 represents the Signal procedure as a Flexform AST. Train and Gate are represented in a similar manner.

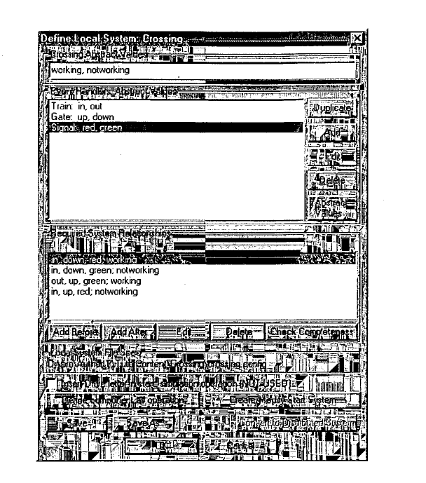

The dialog box in FIG. 6 shows the information required to define the declarative knowledge associated with Crossing system. The Crossing as a whole may be “working” or notworking”. These properties are represented by the Crossing's abstract values. Crossing, in turn, is defined (refined) more precisely in terms of the components (i.e., train, signal and gate) that make up the system.

Specifically, the crossing system is “working” when the train is “in” the crossing, signal is “red” and gate is “down”. It also is working when the train is “out” of the crossing, signal is “green” and gate is “up”. All other Parent-Child mappings correspond to a Crossing that is “networking” (as it should be working). This information is all stored in a Flexform AST as Parent-Child Mappings, and represents declarative knowledge. It should be noted, however, that the list of mappings in FIG. 6 under “Required System Relationships” is only partial. Unlisted combinations of abstract values also result in a system that is networking.

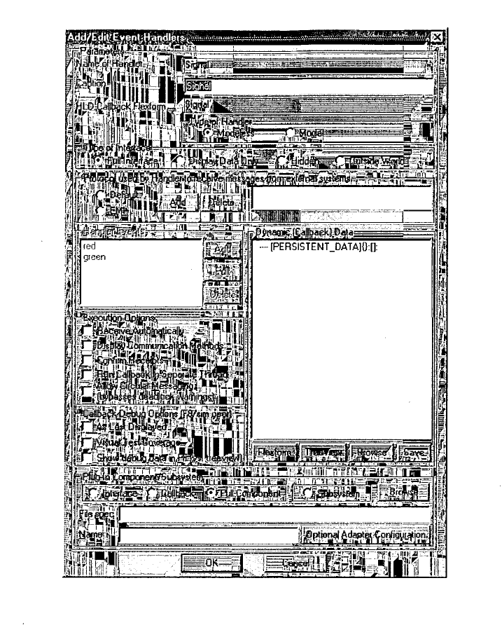

Procedural components (e.g., signal) in the system also may have an (optional) observable interface. In Scandura's SoftBuilder (www.scandura.com) this may be accomplished by simply completing a dialog (see FIG. 7). In the preferred embodiment, such an interface enables a learner to interact with, and hence to simulate the behavior of various components in the system.

Higher Order Behavior and Knowledge. Ill-defined problem domains (i.e., behavioral ASTs) transcend domain specific knowledge. Specifically, such domains typically require higher order knowledge, knowledge that typically is domain independent (also see Scandura, 2001a).

Higher order knowledge (and behavior) is easily represented. Nodes in ASTs may themselves represent ASTs, in which case the (former) AST represents higher order knowledge (or higher order behavior). In the preferred embodiment, any number of knowledge ASTs may be required in solving problems associated with any one Input-Output Knowledge AST. Details on lower as well as higher order representation issues and the method of Structural Analysis for identifying such higher order knowledge are provided in U.S. Pat. No. 6,275,976, Scandura, 2001).

Parent-child mappings in the I-O data structures in higher order knowledge also represent declarative knowledge. Structural analysis, for example, is a higher order process in which the input and output structures are procedural ASTs represented at successive levels of abstraction. That is, each refinement of a parent process results in child processes which collectively generate equivalent behavior. In this case, the parent-child mappings in the data structure ASTs operated on during structural analysis represent declarative knowledge about the process being refined. For example, application of structural analysis in the case of column subtraction results in the AST hierarchy like the successive levels of refinement shown in FIG. 2. Parent-child mappings between these levels represents declarative knowledge, in this case declarative knowledge pertaining to the process of column subtraction.

Input-Output Knowledge ASTs versus Problem ASTs. In the preferred embodiment, Input-Output Knowledge ASTs correspond to formal parameters in a program and represent the data structures on which procedural knowledge operates. Problem ASTs correspond to actual parameters and are copies of Input-Output Knowledge ASTs in which Input variables have been initialized. The values of output variables in problems represent goals values to be determined (from available knowledge).

In most cases, initialization simply amounts to assigning a value or other concrete observable (e.g., via a file reference) to the input variable. Prototype variables, on the other hand, are placeholders for (pointers to) any number of other variables. Initialization of prototype variables amounts to assigning particular variables to the prototype. In FIG. 1, for example, “CurrentColumn” in any given problem can at any point in time represent any one of a fixed number of columns—the “Ones“column, the “Tens” column, the “Hundreds” column, etc. The “top” digit in each column (e.g., tens), in turn, would be assigned a particular digit.

Semantic Attributes.—The author also may assign any number of semantic attributes to nodes in a behavior and/or knowledge AST. We have seen above that semantic attributes in ASTs are used to define procedural (input-output behavior) and/or declarative (parent-child behavior) knowledge. Semantic attributes of nodes also are used to define type of refinement (e.g., category, component, selection, case, loop).

In an Input-Output Knowledge AST or a corresponding problem AST, semantic attributes may be associated with problems as a whole, or with individual nodes. In the former case, the preferred use is to convey or represent observable or other important information about the problem as a whole for example, a verbal statement of the problem or a hint for solving the problem.

Semantic attributes associated with specific nodes in specific problem representations are more aptly called (display) properties. Such properties represent how information is to be presented (made observable) to learners, and/or how responses are to be obtained from learners. The use of observable properties is explained below.

Semantic attributes can also be used to define instruction, questions, positive reinforcement and corrective feedback associated with given nodes. These and other attributes provide almost unlimited latitude in customizing learning or tutorial environments.

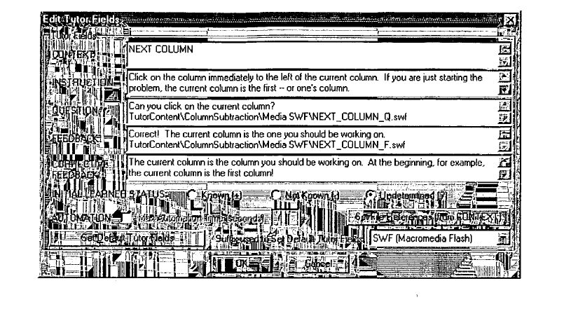

Preferably, semantic attributes are assigned by simply filling out a dialog box or equivalent, such as that shown in FIG. 8.

In FIG. 8, INSTRUCTION, QUESTION, FEEDBACK and CORRECTIVE FEEDBACK include both text and a file reference to supporting multimedia. In this example, all referenced files are audio (.wav) files, although Flash (.swf) files are more commonly used because they combine everything from sound to movies and take considerable less memory. Clicking on “Set Default Tutor Fields” automatically creates the above text from the operation name and its parameters.

Clicking on “Set File References” would automatically add default file references for corresponding Flash (.swf) files. Any number of such references may be included in the preferred embodiment. CONTEXT is essentially an identifier, and in the preferred embodiment is used to automatically name supporting files.

Nodes in an AST also may be given special status. For example, the knowledge (or behavior) associated with a node may be designated to receive special treatment. For example, a non-terminal node may represent knowledge that is so important that it must not only be learned but that it must be mastered (e.g., to a degree consistent with nodes that are atomic in the AST). Conceptually, automation of a node in an AST involves replacing procedural complexity with structural complexity via application of higher order automatization rules (ASTs) to non-automated ones (Scandura, 2001a).

In the preferred embodiment, the author can specify whether the knowledge associated with any given node is to be AUTOMATED. Automation means that the learner must demonstrate mastery to a degree consistent with performance expected if the node were atomic (e.g., terminal). Speed of response is a typical but not the only indicator of automation. To be automated nodes are marked with an “a”, meaning that they are to be “automated”.

Other semantic attributes play an essential role in defining the learner model. In the preferred embodiment, the learner model is defined by status attributes (of operations and/or mappings) in AST nodes. These nodes may be marked known (+), unknown (−), yet to be undetermined (?) or automated (A). (In the case of automation, the lower case “a” is converted to upper case.)

Other distinctions (e.g., partial knowledge) obviously could be introduced, either as replacements or enhancements. As we shall se below, the author preferably is given the option of setting the INITIAL LEARNER STATUS, making it possible to customize tutoring for different populations of learners.

Observable Properties.—In the preferred embodiment, the author may assign observable (aka display) properties to semantic attributes and nodes (e.g., operations, problem variables) in ASTs. These properties specify how information is to be presented to and received from the learner addition to native display machinery for such properties as text, selections and regions defined by simple figures, properties may include a wide variety of file types, such as (.swf) files for Macromedia popular Flash reader, sound (.wav), picture (.bmp) and animation (.avi). Anyone skilled in the art knows that other file types, as well as ActiveX and other object types, also may be supported.

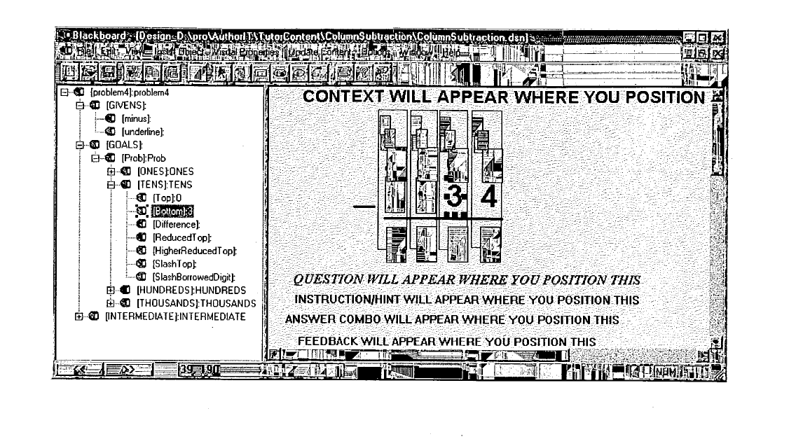

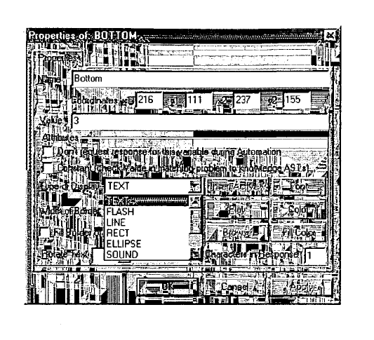

FIG. 9 shows a problem layout (aka problem type) for column subtraction. In addition to initialized input (Given) and output (Goal) variables, display attributes may be assigned to semantic attributes associated with nodes in knowledge ASTs. In the preferred embodiment, properties may be assigned by clicking on an item and selecting properties in a dialog such as that shown in FIG. 10. These properties include value, location, size, kind of response and other characteristics of to be displayed objects.

Since automation has the effect of “chunking” subsumed nodes, the author may select nodes that may safely be ignored during testing (and/or instruction). Other nodes may have constant values, which may be used in helping to identify design ASTs that apply to given problems (e.g., see control mechanism in U.S. Pat. No. 6,275,976, Scandura, 2001).

Such properties, including referenced files, objects, etc., can automatically be displayed whenever associated nodes and/or semantic attributes are referenced by a universally applicable tutor operating on said ASTs (see below). In the preferred embodiment, the kind of input required of the learner (e.g., keyboard for text, click for position, multiple-choice for selection) also may be determined automatically from properties assigned to AST elements.ln addition, the author may specify the kind of evaluation to be used in judging learner responses to individual variables (e.g., exact match, area clicked, external evaluation by learner or teacher).

In the preferred embodiment, properties also may be assigned to abstract values (categories of values—e.g., see U.S. Pat. No. 6,275,976; Scandura, 2003). Parent-Child mappings (representing declarative knowledge) may be defined in terms of executable operations (as preferred with Input-Output mappings). Nonetheless, abstract values provide a convenient way to represent such mappings in the preferred embodiment.

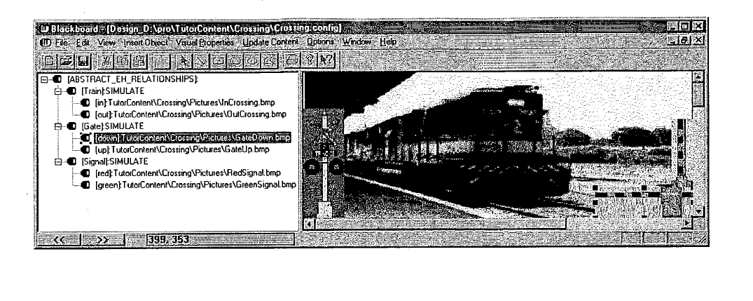

In this embodiment, parent-child mappings in a system are defined in terms of abstract values as illustrated above in FIG. 6. This information is saved in a configuration (.config) file. Because Parent-Child mappings may be defined rather simply in terms of abstract values, displays (i.e., properties) can be defined in an efficient manner. In particular, all combinations of abstract values of the child components in a system can be configured (and represented) in a single Blackboard display. FIG. 11 illustrates the process in the Railroad Crossing system. Possible states of the system are represented in a set of (potentially) overlapping pictures. This display shows a train “in” the station, the signal “red” and the gate “down” (also selected). If one were to select, say, “out” under train, one would see the picture of a train in the country (hidden under the train in the station). Signal can similarly be changed to “green”. The bottom line is that test items and all parent-child relationships can be constructed by referencing the display properties associated with the abstract values.

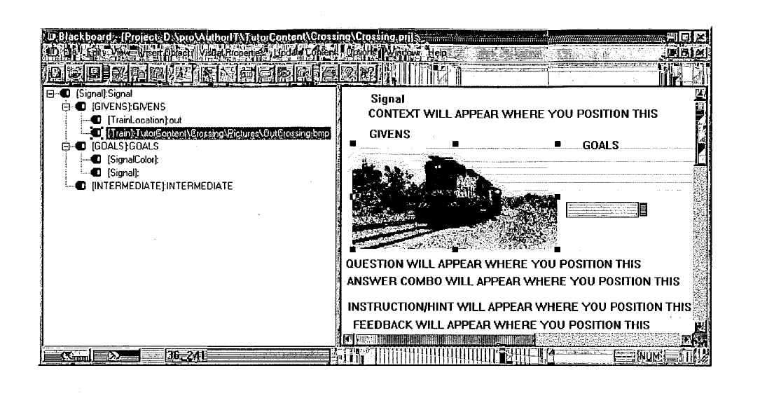

One or more components may be required to solve problems associated with behavior of the Crossing system. FIG. 12 represents a problem, determining the color of Signal based on the location of Train, which can be solved by the Signal component.

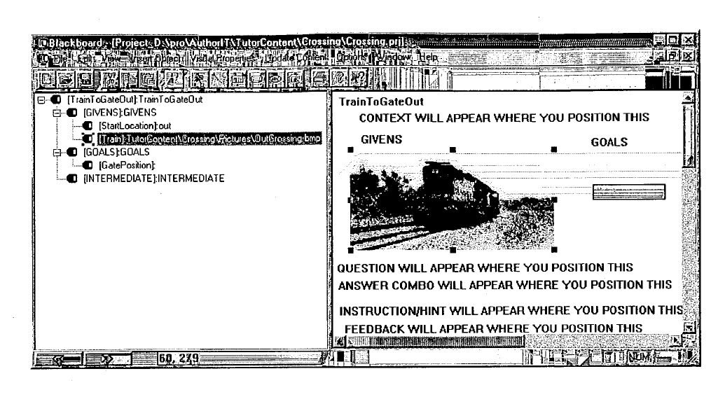

The problem shown in FIG. 13 is more complex. No one component is sufficient itself to solve this problem. Standard approaches that would work in cases like this, include forward and backward chaining. Given the status of Train (“out” of Crossing), the Train component send a message to Signal that it has left (is not “in” the crossing). Signal takes this input and generates a “green” signal. Gate, then receives the signal and goes (or stays) “up”. The question is how to decide which component to use and when to use it.

Standard problem solving mechanisms may not work, however, in more complicated situations involving higher order or domain independent knowledge. Although other mechanisms can obviously be used, the universal control mechanism revealed in (U.S. Pat. No. 6,275,976, Scandura, 2001) is the preferred mechanism to be used for this purpose.

Customizing Learning and Instruction.—.—In the preferred embodiment, the author may customize AST lessons (represented as .dsn or design files) or curricula containing sets of lessons (represented as .prj or project files). In the preferred embodiment, customization consists of setting flags designating particular kinds of learning and/or instruction, such as adaptive, diagnostic, instruction, practice and simulation (see FIG. 14). Delivery Mode is an essential option, designating whether or not to include Diagnosis and/or Tutoring. For example, ADAPTIVE requires both Diagnosis and Tutoring. DIAGNOSIS includes the former and NOT the latter, and vice versa for INSTRUCTION. As noted in FIG. 14, it is possible to devise a wide range of learning and tutoring options by selecting from options, which are easily assigned in behavior and knowledge ASTs. The second note (marked by **), for example, suggests ways to address the needs of a wide range of learners, ranging from those highly knowledgeable in a subject to those entering with minimal prerequisites.

It is also possible, of course, to allow the learner some specified degree of control of the learning and tutoring environment. Such control may be provided in any number of ways. In the preferred embodiment, learner control is allowed by default. It is clear to anyone skilled in the art, however, that allowing learner control of the learning environment may be an option.

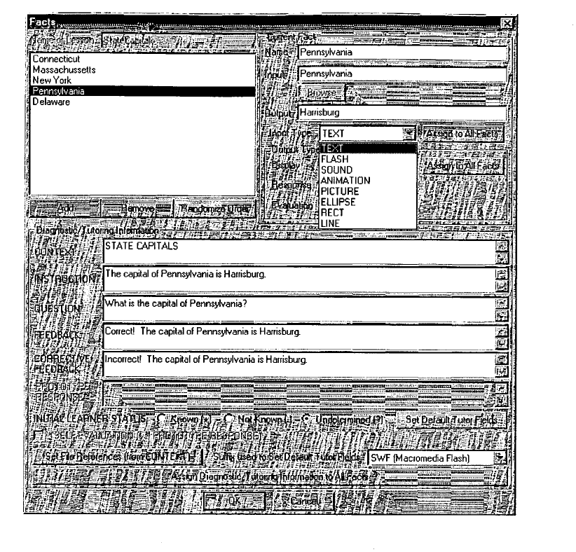

Shortcuts.—Specific kinds of knowledge may be represented in a standard way. As a consequence, short cut methods also may be developed for representing specific kinds of knowledge. ASTs representing factual and conceptual learning, for example, take an especially simple form. These kinds of knowledge are so simple and stylized that the author's job can be further simplified to specifying the desired behavior, eliminating the need to specify what is to be learned. Whereas all of the information in FIG. 15 is textual in nature, notice that the Input and Output Types may involve any kind of multi-media. The information specified defines the desired factual behavior. Given this information, it is possible to automatically construct an AST knowledge representation that is sufficient for constructing said behavior.

Summary.—To summarize, all knowledge is represented as ASTs in which each level of refinement represents equivalent behavior at a different level of abstraction and wherein application of knowledge ASTs to (initialized) Problem ASTs generates a list of (sub)problems to be solved. Each node in said ASTs has a given or computable value, categories of values (a/ka/ abstract values) and other semantic attributes having relevance for learning and instruction, including the learner status. These values, abstract values and semantic attributes, in turn, may be assigned display attributes indicating how they are to be made available to learners.

The above includes methods for: a) creating knowledge ASTs representing both procedural and declarative knowledge, b) assigning semantic attributes to nodes in said ASTs designating important features pertaining to instruction and learner such as instruction, questions and feedback and c) assigning display properties designating how nodes and semantic attributes are to be made observable to learners. In addition, we have revealed how customization parameters designating kinds of diagnosis and/or tutoring may be assigned.

As we shall see, the methods revealed dramatically reduce development times and costs because courseware authors do not have to sequence testing and/or tutoring, nor do they have to pre-specify specific problems or tasks or the order in which testing, instruction and/or feedback is to take place. Shortcut methods also may be developed for factual, conceptual and other kinds of knowledge that can be represented in one or more predetermined type of ASTs.

Universal TutorBased on said Models: Knowledge ASTs of the form described above are both intuitive and executable, and provide a strong foundation for constructing a broad variety of learning and tutoring environments methods disclosed below reveal how learning and instructional can be determined based exclusively on such ASTs and the semantic attributes and properties assigned thereto. Specifically, these methods reveal: a) how specific (sub)problems and their solutions can be generated by applying procedures in knowledge AST to problems defined by Input-Output Knowledge ASTs, b) how semantic attributes associated with nodes in the ASTs determine how to sequence learning and/or tutoring and c) how display attributes assigned to problem ASTs determine how to represent problems and learner responses.

Generating and Solving Problem ASTs.—We have learned above that Problem ASTs (specifications) may, but do not necessarily have to be derived from data structures (Input-Output Knowledge ASTs) associated with procedural ASTs. Assigning values to input nodes (initializing variables represented by said nodes) effectively converts generic Input-Output Knowledge ASTs to concrete problems, where given values of input nodes and to-be-determined values of output nodes effectively define problems or tasks to be solved by learners.

Initialization may be as simple as assigning values or abstract values to said input variables. Input variables may also serve as pointer variables or aliases for any number of other variables (e.g., current_column is an alias for some specific number of columns, such as the one's, ten's and hundred's columns in column subtraction). In this case, each problem derived from an Input-Output Knowledge AST (specification) has a fixed number of variables (in each alias variable) as shown in FIG. 9.

Any number of finer grained (sub)problems may be derived from each such problem. The basic idea is as follows: Knowledge ASTs are executables that act on problems (acting as data). Applying a knowledge AST to a data AST generates a list of sub-problems, one for each node in the knowledge AST. Specifically, (top-down depth first) execution of a knowledge AST on values of the input parameters associated with each operation (node) in a knowledge AST, together with the yet-to-be-determined values of the output values of said operation effectively define a sub-problem to be solved (by the learner).

Given a problem AST (possibly but not necessarily derived from data structures, or formal parameters in knowledge ASTs), said knowledge ASTs may be used either individually or in some combination collectively to both generate specific problems and their solutions. For example, the subtraction problem in FIG. 9 above can be solved by applying the column subtraction algorithm of FIG. 2. FIG. 13 illustrates how individual knowledge ASTs may collectively be executed (in this case one after the other) to generate solutions to composite (railroad-crossing) problems.

As above, problems defined in a “Blackboard” (such as that shown in FIG. 9) effectively define sets of sub-problems. These problem types play an especially important role in the preferred embodiment when they are associated with particular knowledge ASTs as is the case with the GIVEN and GOAL structures in FIG. 9 and the column subtraction Flexform of FIG. 2.

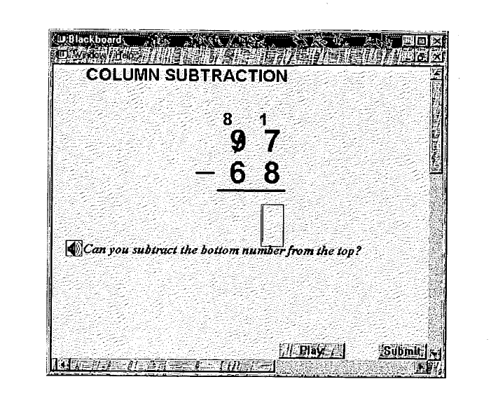

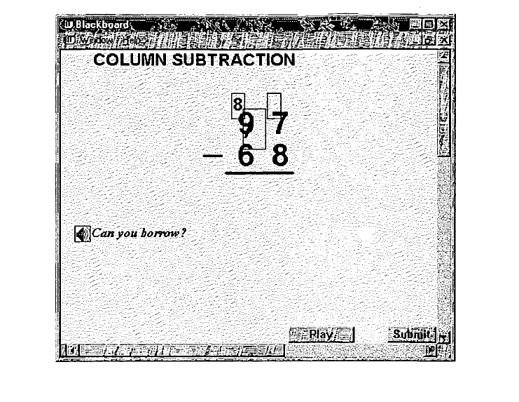

Specifically, each node in a knowledge AST (e.g., column subtraction) determines a unique subproblem. The subproblem is defined by executing the knowledge AST (e.g., using a depth first traversal) on the GIVENS of the initial problem up to the selected node. At this point the problem in puts are fully determined; they are the out puts of the execution up to that point. Furthermore, continuing execution of the AST through the subtree defined by the selected node generates the solution to the problem. For example, FIG. 16 below shows the subproblem defined by applying column subtraction to the sample problem 97−68 up to the point where the learner is asked to find the difference digit in the ones column. FIG. 17 shows a subproblem defined by a non-terminal node representing borrowing in the process of being solved. Notice that the act of borrowing requires three distinct outputs. Crossing out the 9 and entering 8 (above the 9) have already been entered in FIG. 17. The “borrowed” 10 in the one's column is (yet) not shown. Other nodes in column subtraction define problems involving such things identifying (current and borrow) columns and determining whether the top digit is equal to or larger than the bottom digit. In effect, each node in the execution (i.e., sequence of executed nodes) of a procedural AST on a given problem type defines a unique subproblem.

In the preferred embodiment, each node in the corresponding data structure of a knowledge AST includes a parent-child mapping. This mapping also defines a unique problem and its solution a problem representing declarative knowledge. In principle, parent-child mappings may be combined to construct problems testing multi-level declarative knowledge. For example, descendent (e.g., abstract) values may be used to determine ancestor values at any (e.g., grandparent) level.

Moreover, the properties assigned to variables in said problem types uniquely determine how those variables are to be made observable to the learner. For example, if a variable has been assigned a text type, it will automatically be displayed as text. If it is a line, rectangle or ellipse, for example, it will be so represented. Files (e.g., as a .swf or .wav file) or objects (e.g., ActiveX) also may assigned to variables, in which case those variables and/or will be visibly represented by applying corresponding “readers” (e.g., Flash reader).

Output variables also may be assigned types based on their properties. In the preferred embodiment, these types designate the kind of learner input required, and currently include keyboard input (i.e., text) and mouse clicks but it will be clear to anyone skilled in the art that any number of other kinds of input (e.g., touch pads, laser beams, etc.) may be obtained from learners.

Traversing ASTs.—Knowledge ASTs clearly may be traversed in any number of ways (e.g., top-down depth first or breadth first, or bottom up). The default method used in the preferred embodiment, as in most interpreters, is top-down depth first. For example, consider the simple AST

1

11 12

121 122

In this case the default traversal, is the execution sequence (aka execution):

1, 11, 1, 12, 121, 12, 122, 1

Similarly, the default execution associated with the Flexform AST shown in FIG. 2 would be:

ColumnSubtraction, Subtract_the_current_column, Click_on_the_next_column,

Subtract_the_current_column [back up],

Borrow_if_needed_and_subtract_the_current_column, TopGreaterThanBottom,

Borrow_if_needed_and_subtract_the_current_column [back up],

Subtract_the_current_column,

Borrow_if_needed_and_subtract_the_current_column,

Borrow_and_subtract_the_current_column [back up], Borrow_as_appropriate, etc. through NoMoreColumns, ColumnSubtraction

It is clear to anyone skilled in the art, however, that the nodes may be visited in any number of orders, wherein that order is based on either the tree representation or the execution. For example, one can start at the top and go through the nodes in the execution sequentially. Alternatively, one might start with the terminal nodes in the AST and work upward, or from the middle of the AST and move alternatively up and down. It also is possible to skip nodes during a traversal. For example, given any traversal order, one may choose to skip non-terminals in the tree, restricting processing to terminals (or conversely). In the above example, the order would then be 11, 121, 122 (or conversely 1, 12 assuming no repeats). One could also choose whether to repeat nodes already visited (e.g., to omit the repeated 1 and 12 in the above sequence).

Instructional Decision Making.—Strategic and initial learner model and other options set during the authoring process (see FIG. 14) define the kind of diagnosis and tutoring available to learners. In the preferred embodiment, learners also may choose from a variety of learning and instructional types specified by the author. For example, while the author may fine tune the available alternatives by setting a variety of supplemental options adaptive learning, diagnosis, instruction; simulation and practice, the learner may be allowed to select from those options provided.

Customizing the initial learner model and options (e.g., as to diagnosis and instruction) further extends the broad range of possible learning environments. A key point is that if AST representations are consistent and complete as defined in Scandura (U.S. Pat. No. 6,275,976; 2003), such a tutor can actually guarantee student learning.

The methods revealed below literally make it possible to customize the learning and/or tutoring environment. With the click of the key, one can define everything from simple practice, simulation, instruction and performance aid to highly efficient diagnostics or highly optimized adaptive tutoring.

Although the options may be used to define an extensible set of options, application of the methods defined by these options are universally applicable during the course of learning. Given an AST representation of the knowledge to be acquired, these methods reveal how problems/tasks and/or solutions may be generated and learner responses may be evaluated automatically. They further reveal how directly targeted questions, feedback and instruction may be presented at precisely the right time in precisely the right context.

This is accomplished by: (a) selecting nodes in the knowledge ASTs, (b) interpreting said knowledge ASTs on initialized data structures (Problem ASTs) up to said selected nodes, (c) making said partially solved problems observable to the learner in accordance with properties assigned to the nodes in said Problem ASTs, (d) optionally presenting questions and/or instruction (corresponding to said nodes) to the learner, (e) optionally soliciting responses from said learner, (f) executing the subtree defined by said selected node in said knowledge AST, thereby generating the solution to said partially solved problem, (g) optionally evaluating said learner's response to said partially solved problem, (h) optionally presenting solutions, positive and corrective feedback to said learner in accordance with properties assigned to the nodes in said Problem ASTs, (i) maintaining a complete up to date learner model by assigning learner status attributes to each node in said knowledge AST and/or Problem AST and (j) repeating the process until some desired learner model has been achieved or the learner decides to stop.

Although there is a natural order of execution defined by knowledge ASTs, nodes in said ASTs may be selected in any number of orders. Each order corresponds to a specific kind of learning and/or instructional environment, ranging from simple simulation or performance aid to highly adaptive testing and/or instruction. Simulation, for example, consists primarily of executing the knowledge AST on the initialized data structures, thereby illustrating a process. A performance aid might supplement such execution with instruction designating how to perform each step in turn. This can be accomplished by initializing the learner model with all nodes unknown (e.g., marked “−”). Practice simply consists of an initialized learner model in which all nodes are assumed mastered (e.g., marked “+”). When problems are presented, the top-level node is marked “−” so the learner is required to solve them.

Diagnostic testing and adaptive instruction involve slightly more sophisticated logic. Assuming the goal is for the learner to master all AST nodes, for example, all such nodes may initially be designated as undetermined (marked “?”, meaning that the tutor is unaware of whether or not said node has been mastered). This is a prototypic case for highly adaptive tutoring. The tutor may configure the universal tutor to select and test the learner on nodes at or near the middle of a AST hierarchy. For example, options may be set so that success on the partially solved problem defined by a node implies success on all nodes lower in the AST hierarchy. Conversely, failure may imply failure on higher-level nodes (representing more difficult problems). In effect, single test items provide optimal amounts of information about what the learner does and does not know. Similarly, instruction might be targeted at those nodes for which prerequisites have been mastered, rather than subjecting all learners to the same instructional sequence. The latter is the norm in instructional technology because creating highly adaptive instruction is so difficult and time consuming. (Such inferences are strongly supported by empirical research, e.g., see Scandura, 2001a.)

It is clear to anyone skilled in the art that the range of instructional decisions associated with any given node is almost unlimited. Of particular relevance in the preferred embodiment when visiting any particular node is the learner status on that node, as well as on the node's descendents and ancestors. Deciding whether or not to test on the knowledge associated with a given node, for example, might reasonably depend on the amount of information such testing might provide. For example, empirical results indicate that testing on nodes near the middle of an AST make it possible to infer knowledge of both higher and lower level nodes (e.g., Scandura, 2001a). Thus, failure on a node also implies failure on higher-level nodes, whereas success implies success on lower level prerequisites. This makes it possible, respectively, to mark entire super-trees with a “−” or sub-trees with “+”. Similarly, descendents of given nodes have been shown empirically to act as prerequisites, prerequisites that must be mastered (e.g., marked +) before instruction on the given node is likely to be successful.

The options shown in FIG. 14 provide a wide, although obviously not exhaustive, range of options. These options can be set either during authoring or during instructional delivery, in both cases having direct and powerful impact on the kind of learning delivered. Most importantly in the preferred embodiment, the author can predetermine the choice of instructional modes available to the learner. In particular, the author can specify: a) whether instruction is to include diagnosis and/or tutoring, b) whether to simply simulate the behavior, c) whether to provide practice or d) whether to provide the learner with varying degrees of control over what to present next. In the last case, for example, the learner might determine what node comes next as well as whether the associated events involve testing and/or tutoring.

In the preferred embodiment, the author can predetermine: e) the initial status of learners (e.g., by presetting AST nodes to +, − or ?), f) basic instructional strategies (e.g., which node to start with during instruction and whether to base testing and/or instruction on prerequisite knowledge) and g) the amount of supplemental information (e.g., questions, instruction, corrective and positive feedback) to be presented, and under what conditions. It will apparent to those skilled in the art that any number of other options might be used.

In the preferred embodiment, instructional decisions would be made in accordance with the inventor's Structural Leaning Theory (e.g., Scandura, 2001a). This is a natural and preferred choice because of the direct and central role ASTs play in the theory and because the theory is highly operational in nature. Nonetheless, anyone skilled in the art will recognize that instructional decisions based on any number of other conceptual frameworks can be rationalized in terms of the kinds of options listed above and in FIG. 14.

Anyone skilled in the art understands that the evaluation of learner responses and reaction (feedback) thereto play a critical role in learning and instructional environments. Evaluation consists of matching learner responses with responses that either have been predetermined and/or are generated automatically during the course of instruction. In the preferred embodiment, responses are generated as revealed above either by executing subtrees defined by selected nodes in ASTs and/or by input-output and/or parent-child mappings.

The type of evaluation may vary widely. While anyone skilled in the art can devise any number of alternatives, evaluation in the preferred embodiment includes: h) exact matches between learner responses and responses determined by executing ASTs, i) determining whether learner responses (e.g., mouse clicks) fall in pre-designated regions, j) various kinds of probabilistic matching wherein responses meet prescribed or calculated probabilities and k) evaluation of learner responses by an external agent (e.g., teachers).

The preferred kind of evaluation of behavior may differ depending on the problem involved. In the preferred embodiment, for example, a distinction is made between problems that can be solved via a single knowledge AST and problems whose solutions require more than one (knowledge AST). Subtraction provides an example of the former type, as do those railroad-crossing problems that can be solved individually by the train, signal or gate procedures. In these cases, individual nodes in the requisite AST must be evaluated as above.

On the other hand, finding the position of gate, given the train's location, requires all three crossing procedures. Other problems, such as those described in Scandura (2001a), can only be solved by using higher as well as lower order rules. While there are many defensible (and useful) variations, it is assumed in the preferred embodiment that each knowledge AST required in solving a composite problem is known on all-or-none basis. This means effectively that each AST is tested on only one problem. If the learner solves a composite problem correctly, then it is assumed that each of the AST contributing to that success is known. One could reasonably make alternative assumptions, such as requiring nodes in each such AST to be evaluated as above.

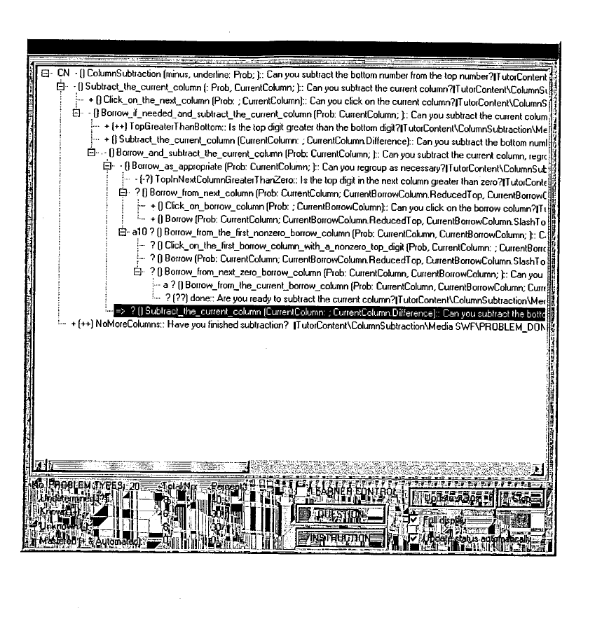

FIG. 18 shows how the learner's status may be represented in the preferred embodiment. In the preferred embodiment, each node is marked with “?”, “+” or “−” (and also could be “a” or “A”). Notice that binary decision nodes (e.g., TopGreaterThanBottom) are designated by “?(??)”, where values inside the parentheses refer to true and false alternatives. Both must be true for the outside “?” to become “+”, whereas any one “−” will make it “−”. In addition, each node includes the associated operation or decision, along with supplemental information (questions, instruction, feedback, etc.). In the preferred embodiment, the learner is also given the option of taking control of his environment at any point during the instruction.

Blackboard Windows and Making Problems and Other Information Observable.—Properties assigned to problem nodes (representing Problem Givens and/or Goals) provide a sufficient basis for communicating with learners. For example, such properties may refer to position on a display, kind of text or other observable (e.g., sound, picture, virtual display, animation, video clip). In the preferred embodiment, information is made observable in one or more windows, which by analogy to the classroom is called a Blackboard.

As anyone skilled in the art is aware, support for said properties may be provided in any number of ways. In the preferred embodiment, native support is provided in a “Blackboard” window for text, simple figures (lines, rectangles, ellipses, etc.) and other observables that can easily be generated directly. More complex observables, including sounds, pictures, animations, 3D, virtual reality, etc. are steadily evolving, and typically are the province of specialized developers. In the preferred embodiment, such observables are represented as files, which in turn are made observable using available readers, many of which are freely distributed (Macromedia's Flash).

When a problem type is selected, the values assigned to the initialized variables in said problem type (i.e., the values of nodes in problem Givens/inputs ASTs) are automatically “displayed” as dictated by the assigned properties. A full range of properties is supported in the preferred embodiment.

Output variables, which represent problem goals, are not assigned initial values. Success in determining the correct values of these goal variables means that the learner has acquired the specified knowledge. Thus, unlike problem givens, goal variables are initially unassigned. In the preferred embodiment, goal variables are initially displayed as placeholders (e.g., grey rectangles). The learner is required to respond (to problems) using available input devices. The choice of input devices is frequently limited to a keyboard and mouse.

More generally, properties assigned to values of output nodes correspond to the input modes available to the learner (e.g., keyboard, mouse, touch pad, stylus, voice activation, head set, etc.). Accordingly, properties assigned to goal variables designate kind of response.

In the preferred embodiment, making declarative knowledge (i.e., parent-child mappings) operational is often simpler using abstract values than using actual values. In addition to nodes, therefore, in the preferred embodiment, “display” properties also are assigned to abstract values associated with nodes. (Abstract values, recall, represent different categories of values that may be distinguished and serve a useful role in learning and instruction.) Since the number of abstract values assigned to a node is finite, possible abstract values (categories of values) may be presented as a choice from which the learner selects.

Semantic attributes are also assigned display properties specifying where and how such things as instruction, questions and feedback are to be made observable to a learner.

Finally, it must be emphasized that display properties apply at all stages in the solution of any problem, and independently of the instructional process. That is, the “display” machinery is completely separate from diagnostic, tutoring and solution processes. Variables, abstract values, semantic attributes, etc. are all displayed (i.e., made observable) based solely on assigned properties, irrespective of the state of the system itself.

Summary.—In summary, knowledge ASTs, including both the processes to be acquired and represented at multiple levels of abstraction, and the data structures on which they operate, represent what is to be acquired. Semantic attributes assigned to nodes in said ASTs provide supplemental information useful in diagnosis and instruction (e.g., questions, instruction, feedback). Semantic attributes also make it possible to define the learner model, indicating what individual learners do and do not know both initially and at any subsequent point in time.

Display properties assigned to nodes in problem type ASTs (possibly but not necessarily derived from data ASTs associated with knowledge to be acquired) define how information is to be represented in an observable interface (aka “blackboard”) to learners and how to receive responses from learners. A wide variety of diagnostic and tutoring options provide constraints on learner and/or automated tutor control of the learning environment. The “Blackboard” environment, supports interactions with learners by representing observables allowing the tutor and learner to communicate. Values, abstract values and semantic attributes, including learner status, are made observable in said blackboard based on the attributes assigned to variables (nodes), abstract values and/or semantic attributes. These “display” attributes are assigned independently of the content in question. Neither the learner nor the tutor need be concerned with these properties.

The methods described above reveal how to generate and solve all possible problems associated with any given set of knowledge ASTs. Problems are generated either by construction or by applying knowledge ASTs to data ASTs up to predetermined node. Solutions to said problems are generated by executing the operations (values) associated with all nodes below said given node. Learner responses are evaluated by comparing said responses with those so generated.

These methods also reveal how the learning environment may be controlled both by various options (e.g., diagnosis and/or tutoring, presenting feedback), by traversal method (whether under automated or learner control) and various kinds of decision making based on those options and the learner model. Given ASTs represented in this manner, it is clear to anyone skilled in the art that any number of ways can be devised to promote learning based entirely on said ASTs (representing the behavior and/or underlying processes to be acquired).

Although the preferred embodiment is based on the Structural Learning Theory, it is clear to anyone skilled in the art that the revealed options, and others that may easily be added, provide a sound foundation for delivering a wide variety instructional models. Furthermore, the few examples presented clearly are only prototypes. It is clear to anyone skilled in the art that the methods revealed might be applied to essentially any type of content. The above examples are all highly structured, in which case the knowledge ASTs are sufficient for solving all problems in a domain. The methods revealed above, however, also apply to less well defined problem domains. For example, in broad based problem solving domains it may not be possible to construct knowledge ASTs that are adequate for solving all potential problems (in the domain). However, such ASTs still provide a useful, albeit incomplete basis for diagnosis and instruction. The only difference is that incomplete and/or inconsistent knowledge representations cannot guarantee learning. Any limitations as to content are solely a function of the ingenuity and resourcefulness of the author.

Knowledge ASTs also make it possible to define almost any kind of learning and/or tutorial environment. For example, while not detailed herein, it is clear that the learner might be allowed to construct problems of his own, wherein said problems may be solved by application of the available knowledge ASTs. The result would serve the learner as automated performance aid. More generally, the learner and/or tutor may generate problems defined by said ASTs, generate solutions to said problems, evaluate learner responses to said problems and provide varying degrees of information during the course of testing (e.g., for diagnosis) and instruction (including, e.g., context, instruction, questions, and feedback).

Range of Application: The methods revealed in U.S. Pat. No. 6,275,976 (Scandura, 2001) and Scandura (2003) are illustrated with sample procedural content. The example, of Column Subtraction can obviously be extended to other arithmetic and algebraic tasks, including basic (e.g., arithmetic) facts and concepts, which are special cases of procedural knowledge. (As above, the latter because of their simplicity require even less input from the author.) The simple Railroad Crossing Model illustrates declarative as well as procedural knowledge. It also illustrates how these methods may be used to model simple problem solving (forward chaining) in well-defined domains.

While these examples are illustrative of the AST models that can be constructed, these examples barely scratch the surface.As illustrated above, it will be clear to anyone skilled in the art how these methods can be extended to ill-defined domains (e.g., U.S. Pat. No. 6,275,976), which include domain independent knowledge.

It also will be clear to those skilled in the art how the methods revealed complement recent emphases on learning objects (e.g., SCORM), including those built with powerful multi-media authoring systems, such as Macromedia's Flash. While reusable learning objects open new opportunities in instructional technology, deciding how to combine these learning objects to achieve given purposes remains the major problem. The methods revealed herein show how individual learning objects (e.g., produced by tools such as Macromedia Flash) may be organized and represented as ASTs. They also reveal how ASTs provide a sound foundation for automatically guiding interaction with learners.

Preferred Embodiment.—The preferred embodiment was implemented using the dialogs shown in FIGS. 1-10 and involves the following:

Knowledge Representation.—Knowledge Representation is based patented processes to create internally consistent specifications and designs represented as ASTs. The preferred embodiment consists of AutoBuilder, a Blackboard Editor and associated display system and a General Purpose Intelligent Tutor (GPIT). AutoBuilder is a software system, which makes it possible to represent arbitrary content as ASTs at multiple levels of abstraction. As any one skilled in the art knows, ASTs may be represented in any number of formally equivalent ways. Whereas any number of other methods may be used for this purpose, the preferred AutoBuilder embodiment makes it possible to create content ASTs in an unambiguous manner so that each level represents equivalent content. This AutoBuilder representation makes it possible to represent both specifications (i.e., behavior) for the input-output behavior and the underlying design processes (i.e., knowledge) associated with that behavior. Content may be represented either by single specification and design ASTs or by any finite number of such ASTs. AutoBuilder is based on methods revealed in U.S. Pat. No. 6,275,976 (Scandura, 2001) and associated theory further elaborated in Scandura (2003).

Although ASTs make it possible to represent both procedural and declarative knowledge, they may be used to represent either kind without the other. In the preferred embodiment, for example, specifying parent-child mappings is not required in representing procedural knowledge—because parent-child mappings are not needed by the General Purpose Tutor (see below) in this case. Hierarchies of Input-Output data structures are still useful, however, because they provide valuable help in suggesting corresponding procedural refinements (as per Table 1). Data structures also are useful in constructing problems (e.g., prototype refinements, such as CurrentColumn, facilitate constructing copies, such as Ones and Tens columns).

As we have seen above, special cases of procedural knowledge, such as Facts and Concepts, require even less input from the author. Solution procedures in these cases can be constructed automatically given only the specific facts and concepts to be learned (i.e., problems to be solved).

Conversely, representing and executing declarative knowledge depends solely on Parent-Child mappings. For example, knowing the status of train, signal and gate is sufficient to determine whether or not a crossing is working. In the preferred embodiment, declarative behavior (e.g., test problems) can be constructed automatically from these mappings.

As shown above, models include both declarative and procedural knowledge. Model representations are also more general than procedural knowledge. In addition to including declarative knowledge, ASTs representing models make it possible to solve problems requiring the use of more than one procedure. Such problems may be constructed, for example, from inputs associated with one procedure in the model and the outputs associated with another. In the current implementation, forward chaining is the control mechanism used to combine the generative power of individual procedures (e.g., train, signal) in model representations.

In the preferred implementation, this control mechanism is further generalized to the universal control mechanism revealed in U.S. Pat. No. 6,275,976 (e.g., Scandura, 2001). (Scandura, 2001a, provides a simpler overview of the universal control mechanism in the context of the Structural Learning Theory.) Universal control provides explicit support for higher order knowledge ASTs, which operate on and/or generate other knowledge ASTs. Higher order knowledge AST, for example, might provide the connection (i.e., mapping) between arithmetic algorithms (e.g., column subtraction and addition) and their more concrete realizations. The latter, for example, might involve the regrouping and manipulation of concrete objects consisting of single (ones), tens, and larger groupings of dowels or Dienes blocks.

In this example, Parent-Child mappings between different levels of abstraction in the subtraction algorithm represent declarative knowledge about the process of column subtraction. Higher order procedural knowledge maps (input) operations in column subtraction to corresponding (output) concrete operations—or vice versa.

Blackboard Editor.—The Blackboard Editor used to create/specify schemata depicting the layout and “display“properties indicating how problems and solution processes, including supplemental information specified by semantic attributes, are to be represented and displayed to the learner. These schemata are essentially instantiations of input-output specifications created with AutoBuilder with specified input values, and intermediate steps in the solution process together with various “display“properties. These “display” properties are used to specify how information (e.g., instruction and feedback from learners) is to be exchanged between learner and tutor, for example, how said problems and intermediate steps in solving such problems are to be displayed or otherwise made observable for purposes of communication between tutor and learner. Problems and instruction may be associated with individual design ASTs or with sets of design ASTs.

LearnerModel.—The Learner Model is defined by assigning a status to each problem type and to each node in the knowledge (i.e., design) ASTs. In the preferred embodiment, each said problem type and each said node is designated as unknown (−), undetermined (?), known (+) and automated (A). Not all nodes need be automated (only those which are specified). In the preferred embodiment, to be automated nodes are designated with a lower case “a”. This is converted to upper case once said node has been automated.

General Purpose Intelligent Tutor (GPI).—The present disclosure also reveals a General Purpose Intelligent Tutor (GPIT), which controls interactions between GPIT and the learner via the Blackboard. Said interactions are based on the content ASTs, the learner model and preset tutor/learner control options. In the preferred embodiment, the latter (control options) make it possible to customize the GPIT to provide a variety of kinds of instruction—ranging from highly adaptive instruction to simulation and performance aid, and variations in between (e.g., progressive instruction beginning with the simplest tasks and with increasing complexity).

The GPIT determines what problems, solution steps, instructions, questions and feedback to present to the learner and when to present them, as well as how to evaluate and react to learner feedback, based entirely on said ASTs, Learner Model and control options.

Decision Making and Built in Interpreter.—In the preferred embodiment, the GPIT is an event handler (a/k/a server) with persistent AST data representing the content to be learned, the learner model (which is superimposed on said content AST) and said control options. The GPIT also has a built in interpreter that can be used to generate both input-output and parent-child behavior as specified in a knowledge AST. The GPIT has complete access to the ASTs, Learner Model and control options. This access is used by GPIT both for purposes of execution and to make diagnostic, tutorial and related decisions. The learner has access to that portion of said information that has been authorized by the author.

In adaptive mode, for example, the GPIT presents at each stage of learning a test item, which determines a maximal amount of information about what the learner already knows and does not know about the content. The GPITs knowledge of the learner's status is updated each time it receives feedback from the learner. In one configuration, the GPIT presents instruction only when the learner's response indicates that he or she has mastered all necessary prerequisites.

Display Independence.—In all cases, the “display” properties operate completely independently in the preferred embodiment. Whereas the GPIT determines what is to be presented at each point in the process, the display properties determine where and the manner in which they are made observable.

Preferred Implementation.—In the preferred embodiment, the Blackboard display is either a web browser or an Event Handler, with its own interface (e.g., Window). The Blackboard displays outputs generated by the GPIT and receives responses from the learner. The Blackboard's callback logic makes it possible for the GPIT and learner to automatically exchange information between themselves. The General Purpose Intelligent Tutor (GPIT) also is an event handler, whose callback logic presents information to and receives information from the Learner based solely on the content ASTs, the Learner Model and Customization options determined by the author and/or learner.

Atomic versus Refined Designs.—Solving problems in the preferred embodiment may involve any number of designs. In the preferred embodiment, when multiple designs are required to solve given problems, the designs are viewed as atomic—meaning that the author is not concerned with distinguishing partial knowledge. This is often the case in complex problem solving where the emphasis is on knowing whether learners know individual designs “well enough” to combine them effectively solve given problems. Although a variety of means may be used to combine multiple designs in problem solving (e.g., forward or backward chaining), solving such problems in the preferred embodiment is in accordance with a universal control mechanism (e.g., U.S. Pat. No. 6,275,976, Scandura, 2001), and may involve both domain specific and domain independent knowledge in accordance with the Structural Learning Theory (Scandura, 2001a).

In contrast, problems used in conjunction with design specific problems typically put emphasis on detailed diagnosis and tutoring. Given any problem (i.e., an initialized specification for the design), individual nodes in said design ASTs define both specific sub-problems to be solved and the associated requisite knowledge to be learned. The operations (designated by nodes) and their parameters represent to be learned behavior and knowledge at various levels of abstraction. The parameters represent the data associated with (sub)problems solvable by the corresponding operation. Mastery of the knowledge associated with any given node, is demonstrated by the learner's the ability to perform ALL steps in the subtree defined by said node. Initial problems are “displayed” automatically based on properties assigned to parameters. The values of output variables generated during the course of execution (in solving the problems) are displayed similarly. Corresponding goal variables associated with sub-problems are “displayed” in accordance with specified response properties (e.g., typed keys).

Nodes may also be specified as to-be-automated. In this case, once the corresponding operation has been learned, the learner is tested only on specified output (or input-output) variables within optional time limits. In effect, automation nodes correspond to operations that are so important that being able to solve them step by step (using prerequisite knowledge) is not sufficient. The learner must demonstrate the ability to generate required results without going through intermediate steps in some acceptable time. In the preferred embodiment, output variables associated with automation nodes may be suppressed (i.e., not displayed). Suppressing an output variable in this manner forces the learner to perform corresponding steps in his or her head, something inherent with the notion of automation.

SemanticAttributes.—Semantic attributes assigned to problems and/or design nodes in the preferred embodiment include supplemental instruction, questions, positive and corrective feedback. These attributes are used to determine what supplemental information to present (questions, instruction, feedback) in addition to the problems and/or solutions themselves. As above, properties assigned to these attributes determine how the semantic attributes are to be “displayed” .(e.g., as text, audio, video, etc.) in the learning-tutoring environment. Alternatively, instruction, questions and even feedback can often be generated automatically from the specified operations themselves. For example, in the preferred embodiment, the name of the operation in a node may be used to provide default instruction. This works quite well in practice when operation names accurately describe the operation at an appropriate level of abstraction.

Display, Response and Evaluation Properties.—Problem variables represent observables used in communication between tutor and learner. Input variables are displayed on a Blackboard in accordance with specified properties (e.g., positions, type of object, selections). These properties determine specifics as to: a) what (e.g., values, sounds, video, etc.) to present, b) where (position), when and how long, c) the kind of feedback to be obtained (e.g., values, positions, selections) and d) the method to be used in evaluating the user responses (e.g., exact, region, probabilistic, “fuzzy”, external).

For example, output variables are assigned “display” properties. In the preferred embodiment, for purposes of simplicity, the properties assigned to display, response and evaluation types have direct parallels: a) display type (e.g., text, shape, selection), b) response or answer type (e.g., edit box [for text], click [for shape] or combo box [for conditions]) and c) evaluation type (e.g., exact [for text], within [for shape], exact match [for selection]) or even external (or self) evaluation.

There is, however, no direct connection. In the preferred embodiment, for example, an external agent also may evaluate answers. Anyone skilled in the art can easily devise the following and other means. Thus, display types might include headsets; response type might include touching the screen or voice; evaluation might include probabilities, Bayesian logic or “fuzzy” sets.

Control Options.—In the preferred embodiment, control of interactive processes (selection of problem AST and/or node in knowledge AST) can be distributed between the automated GPIT and the learner according to pre-specified options. Nonetheless, it is clear that such options might be allocated dynamically.

Because the GPIT is specified independently of specific semantics, only on the AST structure of the to-be-learned content there are any number of methods that might be used to guide learning, testing and/or instruction. As detailed above, the mode of learning and instruction may be fully customized in the preferred embodiment. For example, instruction may be highly adaptive and designed to insure specified learning in the least possible time. Alternatively, it might be configured as a purely diagnostic instrument. Or, instruction might systematically progress from simplest knowledge (e.g., corresponding to prerequisites) to increasingly complex knowledge. It might also be configured for practice, or to act a simple performance aid assisting the learner to perform on some specified set of tasks. At the other extreme the system might be configured to allow the learner to guide his or her own instruction and/or self-directed exploration of the content.

Having thus described our invention, what we claim as new, and desire to secure by Letters Patent is:

1. a computer implemented method for creating and delivering a plurality of learning and tutoring environments, wherein each said system is comprised of at least one learner, a general purpose learning and/or tutoring system, and an optional authoring environment, said method comprising the steps of:
a) one of receiving and constructing at least one abstract syntax tree (AST) representing problems to be mastered by said learners, wherein each said AST includes at one said node representing a goal variable;
b) one of receiving and constructing at least one abstract syntax tree (AST) representing the knowledge to be acquired by said learners, wherein each node in said AST represents at least one of an operation, wherein said operation represents to be acquired procedural knowledge specifying input-output behavior, and data, wherein parent-child mappings between said data nodes represent to be acquired declarative knowledge, wherein at least one of said input-output operation and said parent-child mapping is executable;
c) assigning semantic attributes to nodes in at least one of said problem ASTs of step a) and said knowledge ASTs of step b), wherein said semantic attributes include at least one of tutoring options and context, questions, instructions, answers, hints and feedback and are used by said learning and tutoring system to determine what and how learning and instruction is to be delivered; wherein at least one said semantic attribute represents each said learner's status with respect to said nodes in said AST, wherein said learner status nodes for each said learner collectively represents that said learner's learner model, and wherein said tutoring options include at least one of learner control, tutoring strategy, adaptive instruction, diagnosis, progressive instruction, simulation, practice, initial learner model, and custom variations thereof;
d) assigning “display” properties to at least one of said nodes in step a) and said nodes in step b) and said semantic attributes in said step c), wherein said properties designate what observable object is to represent at least one of said node and said semantic attribute and at least one of the timing, position, duration, the kind of response to be received from said learner and other attributes of said observable object;
e) when said learning and tutoring system is to interact with said learner,
i. at least one of selecting and constructing at least one said problem AST of step a);
ii. selecting a node in at least one said knowledge AST of step b);
iii. generating executing said knowledge ASTs of step b) on said problem AST of step i) up to said selected node in step ii), wherein the resulting problem state represents the subproblem defined by said selected node; wherein values of the input parameters to said selected node constitute the givens in said subproblem and the output parameters of said selected node constitutes the goal in said subproblem;
iv. generating a step-by-step solution to said subproblem of step iii) by executing nodes in the subtree defined by said selected node in said knowledge AST of step ii), wherein execution of the last node in said subtree is the solution to said subproblem;
v. using said “display” properties to at least one of make said nodes and said semantic attributes of step d) observable to said learner and to request responses from said learner;
vi. at least one of said learner responding to said response requests and making decisions as to what to present next and said tutoring system using the result of executing said nodes of step iv) and said learner responses of step v) to update said learner model of step c) and to decide what to present next; and
vii. repeating steps i) through vi) continuing said process until at least one of said learner and said general purpose learning and/or tutoring environment decide to stop.

2. A method in accordance with claim 7, wherein step b) of creating each said executable knowledge AST is in accordance with the methods revealed in U.S. Pat. No. 6,976,275 and Scandura (2003), and further comprises the steps of:
a) for each node in said knowledge AST, specifying at least one of input and output parameters for an operation defined by said node;
b) in response to a request, making said operation of step a) executable, wherein given values of said input parameters of step a), said operation generates corresponding values of said output parameters of step a);
c) refining each said node of step a) into child nodes, wherein said refinement may but need not be in accordance methods revealed in U.S. Pat. No. 6,976,275 and Scandura (2003), wherein each refinement is one of a sequence, parallel, selection, loop, interaction, abstract operation, navigation sequence and terminal;
d) refining each said parameter node of step a) into child nodes, wherein said refinement may but need not be in accordance with the methods revealed in U.S. Pat. No. 6,976,275 and Scandura (2003), wherein each refinement is one of a component, category, prototype, dynamic and terminal;
e) in response to a request, defining an executable parent-child mapping for said parameter refinement of step c), and
f) repeating steps a), b), c), d) and e) on said child nodes until all nodes in said knowledge AST are terminal, wherein each said terminal node defines at least one of an executable terminal operation and an executable parent-child mapping.

3. A method in accordance with claim 1, wherein step a) of receiving and creating each said problem AST, further comprises the steps of:
a) at least one of receiving and constructing a problem AST containing at least one data node, wherein said AST consists of one or more nodes;
b) when a node structure in said problem AST is a copy of a prototype data structure in said AST of step b) of claim 1, creating at least one copy of said prototype structure;
c) when a node resulting from steps a) and b) is to serve as a given in said problem AST, assigning an initial value to said node;
d) assigning “display” properties to at least one node in said problem AST resulting from steps a), b) and c), wherein said properties designate what observable object is to represent said node and at least one of the timing, position, duration, and other attributes of said observable object; and
e) when a node is to serve as a goal in said problem AST, specifying the kind of response to be received from said learner.
